(19) United States
(12) Patent Application Publication
(10) Pub. No.: US 2022/0340746 A1
(43) Pub. Date: Oct. 27, 2022

(54) SEPARATING FIBERS BY MEANS OF POLYION COMPLEXES

(71) Applicant: IONYS AG, Karlsruhe (DE)

(72) Inventors: Detlef BALLSCHUH, Berlin (DE); Horst SEIBT, Berlin (DE); Andreas GERDES, Karlsruhe (DE); Julia SÜSSMUTH, Ettlingen (DE)

(21) Appl. No.: 17/603,858

(22) PCT Filed: Apr. 14, 2020
(86) PCT No.: PCT/EP2020/060481

§ 371 Date: Jul. 1, 2022

(30) Foreign Application Priority Data
Apr. 15, 2019 (DE) 10 2019 205 397.1

(51) Int. Cl. C08L 39/04; C04B 20/10; C04B 20/00; D06M 15/356

(52) U.S. Cl. CPC C08L 39/04; C04B 20/1033; C04B 20/0048; D06M 15/3562; D06M 2200/12

(57) ABSTRACT

Described herein is a polyion complex, including x mol of polycations and y mol of polyanions, x and y being integers from the range of 1 to 100 and x being ≤y or x being ≥y. Also described herein is a method for producing a polyion complex, an aqueous solution of a polyion complex obtained using the method, and the aqueous solution of a polyion complex itself. Also described herein is a method of using a polyion complex to modify the surface of polymer fibers and/or carbon fibers and a method for modifying the surface of polymer fibers and/or carbon fibers using an aqueous solution of the polyion complex. Also described herein are surface-modified polymer fibers and/or carbon fibers obtained using the method, the surface-modified polymer fibers and/or carbon fibers themselves, methods of use thereof to produce fiber-modified construction materials, and a fiber-modified construction material including same.

The invention relates to a polyion complex comprising x mol of polycations and y mol of polyanions, especially for individualization of polymer fibers, wherein x and y are each integers from the range from 1 to 100 and x≤y or x≥y. The invention further relates to a process for preparing a polyion complex, especially an aqueous solution of a polyion complex, to an aqueous solution of a polyion complex obtained or obtainable by the process, and to the aqueous solution of the polyion complex itself. The invention additionally relates to the use of the polyion complex, especially an aqueous solution of the polyion complex for surface modification, especially surface hydrophilization, of polymer fibers, and to a process for surface modification, especially surface hydrophilization, of polymer fibers using an aqueous solution of the polyion complex. The invention likewise relates to surface-modified, especially hydrophilized, polymer fibers obtained or obtainable by the process, and to the surface-modified, especially hydrophilized, polymer fibers themselves. The invention further relates to the use of the surface-modified, especially hydrophilized, polymer fibers for production of fiber-modified building materials, and to a fiber-modified building material comprising surface-modified, especially hydrophilized, polymer fibers.

Polymer fibers, for example polypropylene staple fibers, which are also called multifil or single-hair fibers, serve the particular purpose of producing fiber-modified concrete or mortar systems which, for example, are distinctly less sensitive to cracking than comparable concrete and mortar systems without fibers, in order to enable both more reliable use of such systems and new technical applications.

However, introduction or distribution to the extent that polymer fibers are individualized in such systems is always problematic. For that reason, the fiber surfaces are finished with slips (spin finishing) in order to individualize the polymer fibers with such auxiliaries. When used in fiber-modified concrete or mortar systems, however, the fibers nevertheless have a tendency to mat together and form “tufts, hedgehogs or clusters”. Only a few individual fibers remain.

With regard to this topic, DE 602 22 301 T2 (2002) discloses a further problem that occurs with polymer fibers, for example in the production of fiber-modified concrete: the tendency of large (meaning longer) polymer fibers to clump together in balls that are difficult to break up when they are added to the concrete, which automatically results in worsened concrete properties.

By contrast, a company brochure from Baumbach Metall GmbH on the topic of “Polypropylenfasern zur Reduzierung von Schwindrissen” [Polypropylene Fibers for Reduction of Shrinkage Cracks] claims that “Baumbach PP fibers have special surface preparation in order to be able to assure impeccable processing properties (hydrophilic finish). [ . . . ] Baumbach PP fibers do not make any special demands with regard to mixing time (with fresh concrete). Even mixing times that are inadvertently too long do not lead to cluster, hedgehog or lump formation, or even to fiber breakage as in the case of glass fibers for example.” However, no further details of the chemical structure or physical composition of the hydrophilic finish used for modification of the polypropylene fiber surfaces were given in order thus to be able to plausibly demonstrate the assertions made above.

For that reason, attempts were made, for example, as disclosed by DE 201 21 159 U1 (2001) and EP 1 288 176 B1 (2001) to eliminate the unsatisfactory circumstance of inadequate polymer fiber individualization by adding a flux to a concrete modified with polymer fibers in order that “the polymer fibers are in very homogeneous distribution”. As is apparent from the two working examples cited, 4 kg or 5 kg of flux is used respectively for 3 kg of polymer fibers/m³ of concrete. Fluxes used are either a sulfonate from the group of “lignosulfonate, naphthalene, melaminesulfonate”, or a polycarboxylate or polycarboxylate ether. But no evidence of successful fiber individualization is documented. However, the exceptionally high application rates of flux, namely 1.33 kg to 1.66 kg of flux/kg of polymer fibers, show clearly how inadequate this method is with regard to individualization of polymer fibers.

It is therefore obviously necessary to use greater amounts of flux, since the predominant proportion of the flux interacts preferentially with the other concrete constituents (cement, fly ash, sand and further admixtures in water) particularly in the volume phase of the concrete, rather than with the polymer fibers—i.e. is “lost” unutilized in respect of the actual purpose of attempted individualization of fibers.

V. Mechtcherine [Institute of Construction Materials, TU Dresden (2012), Part 2: Faserbeton {Fiber Concrete}] emphasizes, inter alia, that, for example, the “efficacy of plastic microfibers in the plastic shrinkage requires homogeneous distribution of fine fibers”. Elsewhere, for incorporation of a fire-resistant airplaced concrete with the aid of a spray manipulator, an example of a typical airplaced concrete composition is cited. As well as other admixtures, 1.4% by weight of flux, based on the cement mass of 475 kg of cement/m³ of concrete and 2.7 kg of polypropylene fibers/m³ of concrete, was used for the purpose, corresponding to an amount of flux of about 2.5 kg/kg of polypropylene fibers.

However, no other figures are given for the degree of distribution of the polypropylene fibers used. Elsewhere, however, the hitherto unsolved overall problem of polymer fiber distribution in concrete is clearly emphasized. To wit, in the mixing of fiber concrete, as per the objective, “hedgehog formation” and complete separation are said to be avoided by achieving individualization by sieving prior to the addition to the concrete. Further influencing parameters in this respect are those such as the l/d ratio of the fibers, fiber diameter, fiber content, the largest grain and the water content. No details at all are communicated here either with regard to the degree of distribution of the polymer fibers used.

In summary, it can be stated that the polymer fibers known from the prior art and used are still in need of further improvement for production of fiber-modified concrete or mortar systems.

It was therefore an object of the present invention to provide a treatment agent, especially for cut polymer fiber material, that enables individualization of polymer fibers when these are to serve for production of fiber-modified concrete or mortar systems, in order to avoid the abovementioned disadvantages.

The object was achieved by a polyion complex comprising x mol of polycations and y mol of polyanions, especially for individualization of polymer fibers, wherein x and y are each integers from the range from 1 to 100 and x≤y or x≥y.

In the embedding of fibers into building materials (fiber-modified building materials) that had been surface-modified or hydrophilized with such a polyion complex, it was possible to show that, in the specimens in which polyion complex-modified fibers were used, it was possible to obtain a much more homogeneous individualized distribution of the fibers compared to specimens in which untreated fibers had been embedded. Even for polymer fibers modified with polyion complexes, it was possible to show by studies of fiber individualization in water that, in the case of commercial fiber products, the fibers could be found only in the form of “matted tufts, hedgehogs or clusters” that can be individualized only with great difficulty, if at all, when they are used. By contrast, the polymer fibers modified with polyion complexes showed distinct individualization, which distinctly improves further processibility for introduction into a fiber-modified building material.

In one embodiment of the polyion complex, the polycations are cationic polymers or copolymers, preferably cationic polymers or copolymers having at least one quaternary ammonium cation and further preferably selected from the group consisting of
a) poly-N,N,N-tri-C₁-C₅-alkylammonioalkyl acrylate, wherein the poly-N,N,N-tri-C₁-C₅-alkylammonioalkyl acrylate is preferably selected from the group consisting of poly-N,N,N-[3-(trimethylammonio)ethyl] acrylate, poly-N,N,N-[3-(trimethylammonio)propyl] acrylate, poly-N,N,N-[3-(trimethylammonio)butyl] acrylate, poly-N,N,N-[3-(methyldiethylammonio)propyl] acrylate and mixtures of two or more of these poly-N,N,N-tri-C₁-C₅-alkylammonioalkyl acrylates;
b) poly-N,N,N-tri-C₁-C₅-alkylammonioalkyl methacrylate, wherein the poly-N,N,N-tri-C₁-C₅-alkylammonioalkyl methacrylate is preferably selected from the group consisting of poly-N,N,N-[3-(trimethylammonio)ethyl] methacrylate, poly-N,N,N-[3(trimethylammonio)propyl] methacrylate, poly-N,N,N-[3-(trimethylammonio)butyl] methacrylate, poly-N,N,N[3-(methyldiethylammonio)propyl] methacrylate and mixtures of two or more of these poly-N,N,N-tri-C₁-C₅-alkylammonioalkyl methacrylates;
c) poly-N,N,N-tri-C1-C5-alkylammonioalkylacrylamide, wherein the poly-N,N,N-tri-C₁-C₅-alkylammonioalkylacrylamide is preferably selected from the group consisting of poly-N,N,N[3-(trimethylammonio)ethyl]acrylamide, poly-N,N,N-[3-(trimethylammonio)propyl]acrylamide, poly-N,N,N-[3-(trimethylammonio)butyl]acrylamide, poly-N,N,N-[3-(methyldiethylammonio)propyl]acrylamide and mixtures of two or more of these poly-N,N,N-tri-C₁-C₅-alkylammonioalkylacrylamides;
d) poly-N,N,N-tri-C₁-C₅-alkylammonioalkylmethacrylamide, wherein the poly-N,N,N-tri-C₁-C₅-alkylammonioalkylmethacrylamide is preferably selected from the group consisting of poly-N,N,N-[3-(trimethylammonio)ethyl]methacrylamide, poly-N,N,N-[3-(trimethylammonio)propyl]methacrylamide, poly-N,N,N-[3-(trimethylammonio)butyl]methacrylamide, poly-N,N,N-[3-(methyldiethylammonio)propyl]methacrylamide and mixtures of two or more of these poly-N,N,N-tri-C₁-C₅-alkylammonioalkylmethacrylamides;
e) poly-N-3-methyl-1-vinylimidazolium;
f) quaternized poly [bis(2-chloroethyl) ether-alt-1,3-bis-(3-dimethylamino-propyl)urea];
g) poly(dimethylamine-co-epichlorohydrin-co-ethylenediamine);
h) polydimethyldiallylammonium; and
i) poly(dimethyldiallylammonium-co-methyldiallylamine hydrochloride);
wherein the positive charge of the nitrogen atom of the quaternary ammonium cation is compensated by a singly charged anion, preferably an anion selected from the group consisting of halide anions, especially chloride anion, methosulfate anion, ethosulfate anion and mixtures of two or more of these anions.

The polycations are preferably cationic polymers or copolymers having at least one quaternary ammonium cation and selected from the group consisting of
a.1) poly-N,N,N-tri-C₁-C₅-alkylammonioalkylacrylate chloride or methosulfate, preferably selected from the group consisting of
   poly-N,N,N-[3-(trimethylammonio)ethyl]acrylate chloride,
   poly-N,N,N-[3-(trimethylammonio)propyl]acrylate chloride,
   poly-N,N,N-[3-(trimethylammonio)butyl]acrylate chloride,
   poly-N,N,N-[3-(methyldiethylammonio)propyl]acrylate methosulfate, and mixtures of two or more of these poly-N,N,N-tri-C₁-C₅-alkylammonioalkylacrylate chlorides or methosulfates;
b.1) poly-N,N,N-tri-C₁-C₅-alkylammonioalkylmethacrylate chloride or methosulfate, preferably selected from the group consisting of
   poly-N,N,N-[3-(trimethylammonio)ethyl]methacrylate chloride,
   poly-N,N,N-[3-(trimethylammonio)propyl]methacrylate chloride,
   poly-N,N,N-[3-(trimethylammonio)butyl]methacrylate chloride,
   poly-N,N,N-[3-(methyldiethylammonio)propyl]methacrylate methosulfate, and mixtures of two or more of these poly-N,N,N-tri-C1-C5-alkylammonioalkylmethacrylate chlorides or methosulfates;
c.1) poly-N,N,N-tri-C₁-C₅-alkylammonioalkylacrylamide chloride or methosulfate, preferably selected from the group consisting of
   poly-N,N,N[3-(trimethylammonio)ethyl]acrylamide chloride,
   poly-N,N,N[3-(trimethylammonio)propyl]acrylamide chloride,
   poly-N,N,N[3-(trimethylammonio)butyl]acrylamide chloride,
   poly-N,N,N[3-(methyldiethylammonio)propyl]acrylamide chloride, and mixtures of two or more of these poly-N,N,N-tri-C₁-C₅-alkylammonioalkylacrylamide chlorides or methosulfates;
d.1) poly-N,N,N-tri-C₁-C₅-alkylammonioalkylmethacrylamide chloride or methosulfate, preferably selected from the group consisting of
   poly-N,N,N-[3-(trimethylammonio)ethyl]methacrylamide chloride,
   poly-N,N,N-[3-(trimethylammonio)propyl]methacrylamide chloride,
   poly-N,N,N-[3-(trimethylammonio)butyl]methacrylamide chloride,
   poly-N,N,N-[3-(methyldiethylammonio)propyl]methacrylamide chloride, and mixtures of two or more of these poly-N,N,N-tri-C₁-C₅-alkylammonioalkylmethacrylamide chlorides or methosulfates;
e.1) poly-N-3-methyl-1-vinylimidazolium chloride;
f.1) poly-[bis(2-chloroethyl) ether-alt-1,3-bis-(3-dimethylaminopropyl)urea], quaternized;
g.1) poly(dimethylamine-co-epichlorohydrin-co-ethylenediamine);
h.1) polydimethyldiallylammonium chloride; and
i.1) poly(dimethyldiallylammonium chloride-co-methyldiallylamine hydrochloride).

In one embodiment of the polyion complex, the polyanions are anionic polymers or copolymers present in the form of alkali metal salts, preferably selected from the group consisting of lithium salt, sodium salt and potassium salt, and/or ammonium salts, further preferably as sodium salts.

The anionic polymers or copolymers preferably include at least one polycarboxylate ether (PCE), wherein the at least one PCE is preferably selected from the group consisting of poly(methacrylic acid-co-methacrylic acid-polyethylene glycol monomethyl ether ester), poly(maleic acid-co-methacrylic acid-polyethylene glycol monomethyl ether ester), poly(methacrylic acid-co-methacrylic acid-polyethylene glycol monomethyl ether amide), poly(maleic acid-co-methacrylic acid-polyethylene glycol methyl ether ester), poly(maleic acid-co-methacrylic acid-polyethylene glycol monomethyl ether amide), poly(maleic acid-co-methacrylic acid-polyethylene glycol methylamide), poly(maleic acid-co-polyethylene glycol monoallyl ether-co-polyethylene glycol bismaleamide acid), poly(methacrylic acid-co-polyethylene glycol methyl vinyl ether), poly(maleic acid-co-polyethylene glycol methyl vinyl ether), poly(methacrylic acid-co-polyethylene glycol methyl allyl ether), poly(methacrylic acid-co-polyethylene glycol methyl methallyl ether), poly(maleic acid-co-polyethylene glycol methyl allyl ether), poly(maleic acid-co-polyethylene glycol methyl methallyl ether), poly(maleic acid-co-N,N-diallyl-N-methyl-N-polyethylene glycol monomethyl ether) and

poly(methacrylic acid-co-N,N-diallyl-N-methyl-N-polyethylene glycol),
wherein the polyethylene glycol (or polyethylene glycol methyl ether) radical in the above-listed anionic polymers is —[CH₂—CH₂—O]ₐ—H or —[CH₂—CH₂—O]ₐ—CH₃; wherein a denotes the degree of ethoxylation (number of monomeric repeat ethylene oxide units), wherein a is an integer in the range from 1 to 100; and wherein the negative charge is compensated in each case by one or more single charged cation(s), preferably one cation selected from the group consisting of sodium cation, potassium cation, ammonium cation and mixtures of two or more of these cations.

Polycarboxylate ethers (PCEs) used are especially the alkali metal salts thereof, preferably the sodium salts thereof, further preferably selected from the group consisting of

poly(methacrylic acid-co-methacrylic acid-polyethylene glycol monomethyl ether ester),
poly(maleic acid-co-methacrylic acid-polyethylene glycol monomethyl ether ester),
poly(methacrylic acid-co-methacrylic acid-polyethylene glycol monomethyl ether amide),
poly(maleic acid-co-methacrylic acid-polyethylene glycol monomethyl ether ester),
poly(maleic acid-co-methacrylic acid-polyethylene glycol monomethyl ether amide),
poly(maleic acid-co-methacrylic acid-polyethylene glycol methylamide),
poly(maleic acid-co-polyethylene glycol monoallyl ether-co-polyethylene glycol bismaleamide acid),
poly(methacrylic acid-co-polyethylene glycol methyl vinyl ether),
poly(maleic acid-co-polyethylene glycol methyl vinyl ether),
poly(methacrylic acid-co-polyethylene glycol methyl allyl ether),
poly(methacrylic acid-co-polyethylene glycol methyl methallyl ether),
poly(maleic acid-co-polyethylene glycol methyl allyl ether),
poly(maleic acid-co-polyethylene glycol methyl methallyl ether),
poly(maleic acid-co-N,N-diallyl-N-methyl-N-polyethylene glycol monomethyl ether) and
poly(methacrylic acid-co-N,N-diallyl-N-methyl-N-polyethylene glycol),
wherein the polyethylene glycol (or polyethylene glycol methyl ether) radical in the above-listed anionic polymers is —[CH₂—CH₂—O]ₐ—H or —[CH₂—CH₂—O]ₐ—CH₃; wherein a denotes the degree of ethoxylation (number of monomeric repeat ethylene oxide units), wherein a is an integer in the range from 1 to 100.

In one embodiment of the polyion complex, the anionic polymers or copolymers further comprise one or more further polymers or copolymers selected from the group consisting of
m) poly(2-acrylamido-2-methylpropanesulfonate);
n) poly(p-styrenesulfonic acid);
o) poly(p-styrenesulfonic acid-co-maleic acid);
p) poly(dimethyldiallylammonium-co-acryloylhydroxamatobetaine) partially anionic;
q) poly(meth)acrylate;
r) poly(meth)acrylic acid crosslinked with pentaerythritol triallyl ether [≤0.5 mol %];
s) polymeric natural substances, modified to anionic polymers with alkali metal (especially sodium) chloroacetate or (hydrogen)sulfite, preferably selected from the group consisting of carboxymethylcellulose, carboxymethyl starch, lignosulfonate and mixtures of two or more of these modified polymeric natural substances; and
t) anionic inorganic polymers, preferably selected from the group consisting of hexametaphosphate (PO₃⁻)₆, silicate Si₃O₇²⁻, and mixtures of two or more of these inorganic polymers;
   wherein the negative charge of the in each case is compensated by one or more singly charged cation(s), preferably one cation selected from the group consisting of sodium cation, potassium cation, ammonium cation and mixtures of two or more of these cations.

The further polymers or copolymer are preferably selected from the group consisting of:
m.1) poly(2-acrylamido-2-methylpropanesulfonate) sodium salt;
n.1) poly(p-styrenesulfonic acid) ammonium salt;
o.1) poly(p-styrenesulfonic acid-co-maleic acid) sodium salt;
p.1) poly(dimethyldiallylammonium-co-acryloylhydroxamatobetaine) partial ammonium salt,
q.1) sodium or potassium salts of poly(meth)acrylate;
r.1) poly(meth)acrylic acid crosslinked with pentaerythritol triallyl ether [≤0.5 mol %] and partially neutralized with sodium hydroxide or potassium hydroxide solution to give sodium or potassium salts;
s.1) polymeric natural substances, modified to anionic polymers with sodium chloroacetate, selected from the group consisting of carboxymethylcellulose sodium salt, carboxymethylstarch sodium salt, lignosulfonate sodium salt and mixtures of two or more of these polymeric natural substances; and
t.1) anionic inorganic polymers, selected from the group consisting of
   sodium hexametaphosphate (NaPO₃)₆,
   sodium silicate Na₂Si₃O₇,
   potassium silicate K₂O.nSiO₂,
   lithium polysilicate Li₂O.5SiO₂ and mixtures of two or more of these inorganic polymers.

In one embodiment of the polyion complex, it further comprises one or more nonionic water-soluble monomers, preferably selected from the group consisting of N-vinyllactam, carboxamide and carbonic acid derivative, further preferably from the group consisting of N-vinylpyrrolidone, N-vinylpiperidone, N-vinylcaprolactam and N-vinylformamide, N-vinylacetamide, N-methyl-N-vinylacetamide, acrylamide, methacrylamide, N,N-dimethylacrylamide, N,N-dimethylmethacrylamide, N-methylolmethacrylamide, N-hydroxyethylmethacrylamide, N-hydroxypropylmethacrylamide, vinyl acetate, acrylonitrile and C₁ to C₆-alkyl ethylene glycol (meth)acrylate having 1 to 80 monomeric repeat ethylene oxide units in the ethylene glycol radical.

In one embodiment of the polyion complex, the polyion complex has the general formula (I)

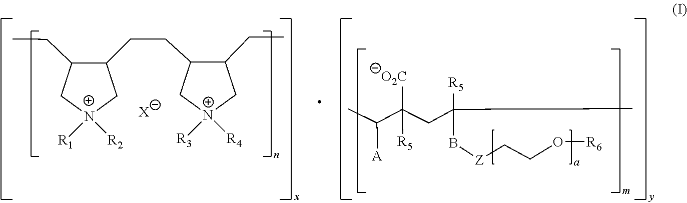

wherein:
R₁, R₂ are independently selected from the group consisting of hydrogen atom, C₁ to C₁₈-alkyl radical, polyethylene glycol radical —[CH₂—CH₂—O]ₐ—H, and polyethylene glycol methyl ether radical —[CH₂—CH₂—O]ₐ—CH₃, wherein a is an integer in the range from 1 to 100;
X⁻ is a halide anion or methosulfate anion, preferably a chloride anion;
R₃, R₄:
   are either independently selected from the group consisting of hydrogen atom, C₁ to C₁₈-alkyl radical, polyethylene glycol radical —[CH₂—CH₂—O]ₐ—H, and polyethylene glycol C₁ to C₁₈-alkyl ether radical, preferably —[CH₂—CH₂—O]ₐ—CH₃, wherein a is an integer in the range from 1 to 100;
   or
   represent a radical of the general formula (II)

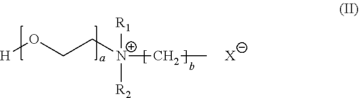

wherein X⁻, R₁, R₂ and a have the definitions given above for the general formula (II), b is 2 or 3;
   or
   represent a radical of the general formula (III)

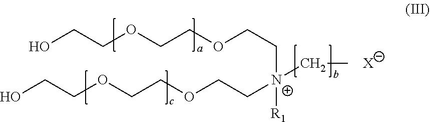

in which X⁻, R₁, a and b have the definitions given above for the general formula (II) or (III) and c is an integer in the range from
   1 to 100;
R₅ is a hydrogen atom or a methyl group;
R₆ is a hydrogen atom or a C₁ to C₁₈-alkyl radical, preferably a methyl group;
A is a hydrogen atom, a carboxylate anion —CO₂⁻ or a carboxylate sodium —CO₂Na,
B is a methylene group —CH₂— or a carbonyl group —CO—, or the bridge group is absent,
Z is an oxygen atom or a nitrogen radical NR₆ with the definition already given for R₆;
n, m are independently either the same or different and denote the degree of polymerization that represents the number of monomeric repeat units in the polymer,
x, y are numbers from the range from 1 to 100, where, preferably, x≥y or x≤y.

In one embodiment of the polyion complex, the polyion complex is in aqueous solution, wherein preferably ≥90% by weight of the aqueous solution of the polyion complex consists of polyion complex and water.

The aqueous solution of the polyion complex preferably comprises more than 10% by weight, preferably more than 20% by weight, further preferably more than 50% by weight, of water, based on the total weight of the respective aqueous solution.

In one embodiment of the polyion complex, the aqueous solution of the polyion complex has a pH in the range from 6 to 9.

### Process For Preparing a Polyion Complex

The invention further relates to a process for preparing a polyion complex, especially an aqueous solution of a polyion complex, wherein the polyion complex comprises x mol of polycations and y mol of polyanions, wherein x and y are each integers from the range from 1 to 100 and x≤y or x≥y, comprising:
1) providing an aqueous solution of a polycation component or an aqueous solution of a polyanion component;
2) adding an aqueous solution of a polyanion component or an aqueous solution of a polycation component to the aqueous solution of the polycation component or of the polyanion component provided in (1);
to obtain an aqueous solution of a polyion complex.

In one embodiment of the process for preparing a polyion complex, the addition in step (2) is effected at a temperature in the range from 0° C. to 50° C., preferably between 15° C. and 30° C.

In one embodiment of the process for preparing a polyion complex, the aqueous solution of the polyanion component comprises further additions selected from the group consisting of neutralizing agents, preferably selected from the group consisting of potassium carbonate, sodium carbonate, sodium hydroxide solution, potassium hydroxide solution or mixtures of two or more of these neutralizing agents; extra added electrolyte, preferably sodium chloride; surfactant, preferably sodium lauryl ether sulfates; and mixtures of two or more of these additions.

The addition of a surfactant serves for better distribution of the polyion complex or of the treatment agent in use. Preferred surfactants are selected from the group of the ethoxylated n-alkyl surfactants, such as sodium lauryl ether sulfate, N-n-hexadecyl/n-octadecyl-N,N-bis(pentaethylene glycol)amine oxide, N-n-dodecyl/n-tetradecyl-N,N-bis(diethylene glycol)-2-sulfinato-3-sulfopropylammoniobetaine sodium salt, N-n-dodecyl/n-tetradecyl-N,N-bis(diethylene glycol)-2,3-disulfopropylammoniobetaine sodium salt, N-n-hexadecyl/n-octadecyl-N,N-bis(pentaethylene glycol)-2-sulfinato-3-sulfopropylammoniobetaine sodium salt and N-n-hexadecyl/-n-octadecyl-N,N-bis(pentaethylene glycol)-2,3-disulfopropylammoniobetaine sodium salt; the surfactant used is preferably at least sodium lauryl ether sulfate.

As a result of the electrostatic charge of the macromolecule, the dissolution of polyanions in aqueous solution may lead to a significant rise in viscosity in the solution, but this can be largely avoided by a sufficiently high addition of extra electrolyte, for example sodium chloride, to the solution (B. Philipp and G. Reinisch “Grundlagen der makromolekularen Chemie” [Fundamentals of Macromolecular Chemistry], Akademie-Verlag-Berlin, 1976).

In one embodiment of the process for preparing a polyion complex, the polycations are cationic polymers or copolymers, preferably cationic polymers or copolymers having at least one quaternary ammonium cation and further preferably selected from the group consisting of
a) poly-N,N,N-tri-C₁-C₅-alkylammonioalkyl acrylate, wherein the poly-N,N,N-tri-C₁-C₅-alkylammonioalkyl acrylate is preferably selected from the group consisting of poly-N,N,N-[3-(trimethylammonio)ethyl] acrylate, poly-N,N,N-[3-(trimethylammonio)propyl] acrylate, poly-N,N,N-[3-(trimethylammonio)butyl] acrylate, poly-N,N,N-[3-(methyldiethylammonio)propyl] acrylate and mixtures of two or more of these poly-N,N,N-tri-C₁-C₅-alkylammonioalkyl acrylates;
b) poly-N,N,N-tri-C₁-C₅-alkylammonioalkyl methacrylate, wherein the poly-N,N,N-tri-C₁-C₅-alkylammonioalkyl methacrylate is preferably selected from the group consisting of poly-N,N,N-[3-(trimethylammonio)ethyl] methacrylate, poly-N,N,N-[3(trimethylammonio)propyl] methacrylate, poly-N,N,N-[3-(trimethylammonio)butyl] methacrylate, poly-N,N,N[3-(methyldiethylammonio)propyl] methacrylate and mixtures of two or more of these poly-N,N,N-tri-C₁-C₅-alkylammonioalkyl methacrylates;
c) poly-N,N,N-tri-C1-C5-alkylammonioalkylacrylamide, wherein the poly-N,N,N-tri-C₁-C₅-alkylammonioalkylacrylamide is preferably selected from the group consisting of poly-N,N,N[3-(trimethylammonio)ethyl]acrylamide, poly-N,N,N-[3-(trimethylammonio)propyl]acrylamide, poly-N,N,N-[3-(trimethylammonio)butyl]acrylamide, poly-N,N,N-[3-(methyldiethylammonio)propyl]acrylamide and mixtures of two or more of these poly-N,N,N-tri-C₁-C₅-alkylammonioalkylacrylamides;
d) poly-N,N,N-tri-C₁-C₅-alkylammonioalkylmethacrylamide, wherein the poly-N,N,N-tri-C₁-C₅-alkylammonioalkylmethacrylamide is preferably selected from the group consisting of poly-N,N,N-[3-(trimethylammonio)ethyl]methacrylamide, poly-N,N,N-[3-(trimethylammonio)propyl]methacrylamide, poly-N,N,N-[3-(trimethylammonio)butyl]methacrylamide, poly-N,N,N-[3-(methyldiethylammonio)propyl]methacrylamide and mixtures of two or more of these poly-N,N,N-tri-C₁-C₅-alkylammonioalkylmethacrylamides;
e) poly-N-3-methyl-1-vinylimidazolium;
f) quaternized poly [bis(2-chloroethyl) ether-alt-1,3-bis-(3-dimethylamino-propyl)urea];
g) poly(dimethylamine-co-epichlorohydrin-co-ethylenediamine);
h) polydimethyldiallylammonium; and
i) poly(dimethyldiallylammonium-co-methyldiallylamine hydrochloride);
   wherein the positive charge of the nitrogen atom of the quaternary ammonium cation is compensated by a singly charged anion, preferably an anion selected from the group consisting of halide anions, especially chloride anion, methosulfate anion, ethosulfate anion and mixtures of two or more of these anions.

In one embodiment of the process for preparing a plyion complex, the polycations are preferably cationic polymers or copolymers having at least one quaternary ammonium cation and selected from the group consisting of
a.1) poly-N,N,N-tri-C₁-C₅-alkylammonioalkylacrylate chloride or methosulfate, preferably selected from the group consisting of
   poly-N,N,N-[3-(trimethylammonio)ethyl]acrylate chloride,
   poly-N,N,N-[3-(trimethylammonio)propyl]acrylate chloride,
   poly-N,N,N-[3-(trimethylammonio)butyl]acrylate chloride,
   poly-N,N,N-[3-(methyldiethylammonio)propyl]acrylate methosulfate, and mixtures of two or more of these poly-N,N,N-tri-C₁-C₅-alkylammonioalkylacrylate chlorides or methosulfates;
b.1) poly-N,N,N-tri-C₁-C₅-alkylammonioalkylmethacrylate chloride or methosulfate, preferably selected from the group consisting of
   poly-N,N,N-[3-(trimethylammonio)ethyl]methacrylate chloride,
   poly-N,N,N-[3-(trimethylammonio)propyl]methacrylate chloride,
   poly-N,N,N-[3-(trimethylammonio)butyl]methacrylate chloride,
   poly-N,N,N-[3-(methyldiethylammonio)propyl]methacrylate methosulfate, and mixtures of two or more of these poly-N,N,N-tri-C1-C5-alkylammonioalkylmethacrylate chlorides or methosulfates;
c.1) poly-N,N,N-tri-C₁-C₅-alkylammonioalkylacrylamide chloride or methosulfate, preferably selected from the group consisting of
   poly-N,N,N[3-(trimethylammonio)ethyl]acrylamide chloride,
   poly-N,N,N[3-(trimethylammonio)propyl]acrylamide chloride,
   poly-N,N,N[3-(trimethylammonio)butyl]acrylamide chloride,
   poly-N,N,N[3-(methyldiethylammonio)propyl]acrylamide chloride, and mixtures of two or more of these poly-N,N,N-tri-C₁-C₅-alkylammonioalkylacrylamide chlorides or methosulfates;
d.1) poly-N,N,N-tri-C₁-C₅-alkylammonioalkylmethacrylamide chloride or methosulfate, preferably selected from the group consisting of
   poly-N,N,N-[3-(trimethylammonio)ethyl]methacrylamide chloride,
   poly-N,N,N-[3-(trimethylammonio)propyl]methacrylamide chloride,
   poly-N,N,N-[3-(trimethylammonio)butyl]methacrylamide chloride,
   poly-N,N,N-[3-(methyldiethylammonio)propyl]methacrylamide chloride, and mixtures of two or more of these poly-N,N,N-tri-C₁-C₅-alkylammonioalkylmethacrylamide chlorides or methosulfates;
e.1) poly-N-3-methyl-1-vinylimidazolium chloride;
f.1) poly-[bis(2-chloroethyl) ether-alt-1,3-bis-(3-dimethylaminopropyl)urea], quaternized;
g.1) poly(dimethylamine-co-epichlorohydrin-co-ethylenediamine);
h.1) polydimethyldiallylammonium chloride; and
i.1) poly(dimethyldiallylammonium chloride-co-methyldiallylamine hydrochloride).

In one embodiment of the process for preparing a polyion complex, the polyanions are anionic polymers or copolymers present in the form of alkali metal salts, preferably selected from the group consisting of lithium salt, sodium salt and potassium salt, and/or ammonium salts, further preferably as sodium salts.

In a preferred embodiment of the process for preparing a polyion complex, the anionic polymers or copolymers include at least one at least one polycarboxylate ether (PCE), wherein the at least one PCE is preferably selected from the group consisting of poly(methacrylic acid-co-methacrylic acid-polyethylene glycol monomethyl ether ester), poly(maleic acid-co-methacrylic acid-polyethylene glycol monomethyl ether ester), poly(methacrylic acid-co-methacrylic acid-polyethylene glycol monomethyl ether amide),

poly(maleic acid-co-methacrylic acid-polyethylene glycol methyl ether ester),
poly(maleic acid-co-methacrylic acid-polyethylene glycol monomethyl ether amide),
poly(maleic acid-co-methacrylic acid-polyethylene glycol methylamide), poly(maleic acid-co-polyethylene glycol monoallyl ether-co-polyethylene glycol bismaleamide acid),
poly(methacrylic acid-co-polyethylene glycol methyl vinyl ether), poly(maleic acid-co-polyethylene glycol methyl vinyl ether), poly(methacrylic acid-co-polyethylene glycol methyl allyl ether), poly(methacrylic acid-co-polyethylene glycol methyl methallyl ether),
poly(maleic acid-co-polyethylene glycol methyl allyl ether), poly(maleic acid-co-polyethylene glycol methyl methallyl ether), poly(maleic acid-co-N,N-diallyl-N-methyl-N-polyethylene glycol monomethyl ether) and
poly(methacrylic acid-co-N,N-diallyl-N-methyl-N-polyethylene glycol),
wherein the polyethylene glycol (or polyethylene glycol methyl ether) radical in the above-listed anionic polymers is —[CH₂—CH₂—O]ₐ—H or —[CH₂—CH₂—O]ₐ—CH₃; wherein a denotes the degree of ethoxylation (number of monomeric repeat ethylene oxide units), wherein a is an integer in the range from 1 to 100; and wherein the negative charge is compensated in each case by one or more single charged cation(s), preferably one cation selected from the group consisting of sodium cation, potassium cation, ammonium cation and mixtures of two or more of these cations.

For the process for preparing a polyion complex, the polycarboxylate ethers (PCEs) preferably used are especially the alkali metal salts thereof, preferably the sodium salts thereof, further preferably selected from the group consisting of

poly(methacrylic acid-co-methacrylic acid-polyethylene glycol monomethyl ether ester),
poly(maleic acid-co-methacrylic acid-polyethylene glycol monomethyl ether ester),
poly(methacrylic acid-co-methacrylic acid-polyethylene glycol monomethyl ether amide),
poly(maleic acid-co-methacrylic acid-polyethylene glycol monomethyl ether ester),
poly(maleic acid-co-methacrylic acid-polyethylene glycol monomethyl ether amide),
poly(maleic acid-co-methacrylic acid-polyethylene glycol methylamide),
poly(maleic acid-co-polyethylene glycol monoallyl ether-co-polyethylene glycol bismaleamide acid),
poly(methacrylic acid-co-polyethylene glycol methyl vinyl ether),
poly(maleic acid-co-polyethylene glycol methyl vinyl ether),
poly(methacrylic acid-co-polyethylene glycol methyl allyl ether),
poly(methacrylic acid-co-polyethylene glycol methyl methallyl ether),
poly(maleic acid-co-polyethylene glycol methyl allyl ether),
poly(maleic acid-co-polyethylene glycol methyl methallyl ether),
poly(maleic acid-co-N,N-diallyl-N-methyl-N-polyethylene glycol monomethyl ether) and
poly(methacrylic acid-co-N,N-diallyl-N-methyl-N-polyethylene glycol),
wherein the polyethylene glycol (or polyethylene glycol methyl ether) radical in the above-listed anionic polymers is —[CH₂—CH₂—O]ₐ—H or —[CH₂—CH₂—0]ₐ—CH₃; wherein a denotes the degree of ethoxylation (number of monomeric repeat ethylene oxide units), wherein a is an integer in the range from 1 to 100.

In one embodiment of the process for preparing a polyion complex, the polymers or copolymers further comprise one or more further polymers or copolymers selected from the group consisting of
m) poly(2-acrylamido-2-methylpropansulfonate);
n) poly(p-styrenesulfonic acid);
o) poly(p-styrenesulfonic acid-co-maleic acid);
p) poly(dimethyldiallylammonium-co-acryloylhydroxamatobetaine) partially anionic;
q) poly(meth)acrylate;
r) poly(meth)acrylic acid crosslinked with pentaerythritol triallyl ether [≤0.5 mol %];
s) polymeric natural substances, modified to anionic polymers with alkali metal (especially sodium) chloroacetate or (hydrogen)sulfite, preferably selected from the group consisting of carboxymethylcellulose, carboxymethyl starch, lignosulfonate and mixtures of two or more of these modified polymeric natural substances; and
t) anionic inorganic polymers, preferably selected from the group consisting of hexametaphosphate (PO₃⁻)₆, silicate Si₃O₇²⁻, and mixtures of two or more of these inorganic polymers;
   wherein the negative charge of the in each case is compensated by one or more singly charged cation(s), preferably one cation selected from the group consisting of sodium cation, potassium cation, ammonium cation and mixtures of two or more of these cations.

For the process for preparing the polyion complex, the further polymers or copolymer are preferably selected from the group consisting of
m.1) poly(2-acrylamido-2-methylpropanesulfonate) sodium salt;
n.1) poly(p-styrenesulfonic acid) ammonium salt;
o.1) poly(p-styrenesulfonic acid-co-maleic acid) sodium salt;
p.1) poly(dimethyldiallylammonium-co-acryloylhydroxamatobetaine) partial ammonium salt,
q.1) sodium or potassium salts of poly(meth)acrylate;
r.1) poly(meth)acrylic acid crosslinked with pentaerythritol triallyl ether [≤0.5 mol %] and partially neutralized with sodium hydroxide or potassium hydroxide solution to give sodium or potassium salts;
s.1) polymeric natural substances, modified to anionic polymers with sodium chloroacetate, selected from the group consisting of carboxymethylcellulose sodium salt, carboxymethylstarch sodium salt, lignosulfonate sodium salt and mixtures of two or more of these polymeric natural substances; and
t.1) anionic inorganic polymers, selected from the group consisting of
   sodium hexametaphosphate (NaPO₃)₆,
   sodium silicate Na₂Si₃O₇,
   potassium silicate K₂O.nSiO₂,
   lithium polysilicate Li₂O.5SiO₂ and mixtures of two or more of these inorganic polymers.

In one embodiment of the process for preparing a polyion complex, the polyion complex further comprises one or more nonionic water-soluble monomers, preferably selected from the group consisting of N-vinyllactam, carboxamide and carbonic acid derivative, further preferably from the group consisting of N-vinylpyrrolidone, N-vinylpiperidone, N-vinylcaprolactam and N-vinylformamide,

N-vinylacetamide, N-methyl-N-vinylacetamide, acrylamide, methacrylamide, N,N-dimethylacrylamide, N,N-dimethylmethacrylamide, N-methylolmethacrylamide, N-hydroxyethylmethacrylamide, N-hydroxypropylmethacrylamide, vinyl acetate, acrylonitrile and C₁ to C₆-alkyl ethylene glycol (meth)acrylate having 1 to 80 monomeric repeat ethylene oxide units in the ethylene glycol radical.

In a preferred embodiment of the process for preparing a polyion complex, the polyion complex has the general formula (I)

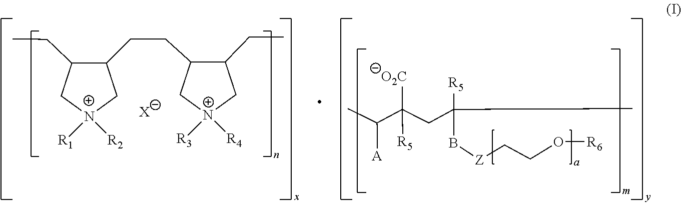

wherein:
R₁, R₂ are independently selected from the group consisting of hydrogen atom, C₁ to C₁₈-alkyl radical, polyethylene glycol radical —[CH₂—CH₂—O]ₐ—H, and polyethylene glycol methyl ether radical —[CH₂—CH₂—O]ₐ—CH₃, wherein a is an integer in the range from 1 to 100;
X⁻ is a halide anion or methosulfate anion, preferably a chloride anion;
   R₃, R₄:
      are either independently selected from the group consisting of hydrogen atom, C₁ to C₁₈-alkyl radical, polyethylene glycol radical —[CH₂—CH₂—O]ₐ—H, and polyethylene glycol C₁ to C₁₈-alkyl ether radical, preferably —[CH₂—CH₂—O]ₐ—CH₃, wherein a is an integer in the range from 1 to 100;
   or
   represent a radical of the general formula (II)

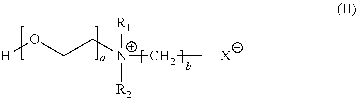

wherein X⁻, R₁, R₂ and a have the definitions given above for the general formula (II), b is 2 or 3;
   or
   represent a radical of the general formula (III)

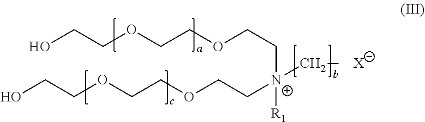

in which X⁻, R₁, a and b have the definitions given above for the general formula (II) or (III) and c is an integer in the range from
   1 to 100;
R₅ is a hydrogen atom or a methyl group;
R₆ is a hydrogen atom or a C₁ to C₁₈-alkyl radical, preferably a methyl group;
A is a hydrogen atom, a carboxylate anion —CO₂⁻ or a carboxylate sodium —CO₂Na,
B is a methylene group —CH₂— or a carbonyl group —CO—, or the bridge group is absent,
Z is an oxygen atom or a nitrogen radical NR₆ with the definition already given for R₆;
n, m are independently either the same or different and denote the degree of polymerization that represents the number of monomeric repeat units in the polymer,
x, y are numbers from the range from 1 to 100, where, preferably, x≥y or x≤y.

In one embodiment of the process for preparing a polyion complex, the polyion complex is in aqueous solution, wherein preferably ≥90% by weight of the aqueous solution of the polyion complex consists of polyion complex and water.

In one embodiment of the process for preparing a polyion complex, the aqueous solution of the polyion complex comprises more than 10% by weight, preferably more than 20% by weight, further preferably more than 50% by weight, of water, based on the total weight of the respective aqueous solution.

In one embodiment of the process for preparing a polyion complex, the aqueous solution of the polyion complex has a pH in the range from 6 to 9.

The invention further relates to an aqueous solution of a polyion complex obtained or obtainable by the process described above.

### Aqueous Solution of a Polyion Complex

The invention likewise relates to an aqueous solution of a polyion complex comprising x mol of polycations and y mol of polyanions, wherein x and y are each integers from the range from 1 to 100 and x≤y or x≥y.

In one embodiment of the aqueous solution of a polyion complex, the polycations are cationic polymers or copolymers, preferably cationic polymers or copolymers having at least one quaternary ammonium cation and further preferably selected from the group consisting of
a) poly-N,N,N-tri-C₁-C₅-alkylammonioalkyl acrylate, wherein the poly-N,N,N-tri-C₁-C₅-alkylammonioalkyl acrylate is preferably selected from the group consisting of poly-N,N,N-[3-(trimethylammonio)ethyl] acrylate, poly-N,N,N-[3-(trimethylammonio)propyl] acrylate, poly-N,N,N-[3-(trimethylammonio)butyl] acrylate, poly-N,N,N-[3-(methyldiethylammonio)propyl] acrylate and mixtures of two or more of these poly-N,N,N-tri-C₁-C₅-alkylammonioalkyl acrylates;
b) poly-N,N,N-tri-C₁-C₅-alkylammonioalkyl methacrylate, wherein the poly-N,N,N-tri-C₁-C₅-alkylammonioalkyl methacrylate is preferably selected from the group consisting of poly-N,N,N-[3-(trimethylammonio)ethyl] methacrylate, poly-N,N,N-[3(trimethylammonio)propyl] methacrylate, poly-N,N,N-[3-(trimethylammonio)butyl] methacrylate, poly-N,N,N[3-(methyldiethylammonio)propyl] methacrylate and mixtures of two or more of these poly-N,N,N-tri-C₁-C₅-alkylammonioalkyl methacrylates;
c) poly-N,N,N-tri-C1-C5-alkylammonioalkylacrylamide, wherein the poly-N,N,N-tri-C₁-C₅-alkylammonioalkylacrylamide is preferably selected from the group consisting of poly-N,N,N[3-(trimethylammonio)ethyl]acrylamide, poly-N,N,N-[3-(trimethylammonio)propyl]acrylamide, poly-N,N,N-[3-(trimethylammonio)butyl]acrylamide, poly-N,N,N-[3-(methyldiethylammonio)propyl]acrylamide and mixtures of two or more of these poly-N,N,N-tri-C₁-C₅-alkylammonioalkylacrylamides;
d) poly-N,N,N-tri-C₁-C₅-alkylammonioalkylmethacrylamide, wherein the poly-N,N,N-tri-C₁-C₅-alkylammonioalkylmethacrylamide is preferably selected from the group consisting of poly-N,N,N-[3-(trimethylammonio)ethyl]methacrylamide, poly-N,N,N-[3-(trimethylammonio)propyl]methacrylamide, poly-N,N,N-[3-(trimethylammonio)butyl]methacrylamide, poly-N,N,N-[3-(methyldiethylammonio)propyl]methacrylamide and mixtures of two or more of these poly-N,N,N-tri-C₁-C₅-alkylammonioalkylmethacrylamides;
e) poly-N-3-methyl-1-vinylimidazolium;
f) quaternized poly [bis(2-chloroethyl) ether-alt-1,3-bis-(3-dimethylamino-propyl)urea];
g) poly(dimethylamine-co-epichlorohydrin-co-ethylenediamine);
h) polydimethyldiallylammonium; and
i) poly(dimethyldiallylammonium-co-methyldiallylamine hydrochloride);
   wherein the positive charge of the nitrogen atom of the quaternary ammonium cation is compensated by a singly charged anion, preferably an anion selected from the group consisting of halide anions, especially chloride anion, methosulfate anion, ethosulfate anion and mixtures of two or more of these anions.

For the aqueous solution of the polyion complex, the polycations are preferably cationic polymers or copolymers having at least one quaternary ammonium cation and selected from the group consisting of
a.1) poly-N,N,N-tri-C₁-C₅-alkylammonioalkylacrylate chloride or methosulfate, preferably selected from the group consisting of
   poly-N,N,N-[3-(trimethylammonio)ethyl]acrylate chloride,
   poly-N,N,N-[3-(trimethylammonio)propyl]acrylate chloride,
   poly-N,N,N-[3-(trimethylammonio)butyl]acrylate chloride,
   poly-N,N,N-[3-(methyldiethylammonio)propyl]acrylate methosulfate, and mixtures of two or more of these poly-N,N,N-tri-C₁-C₅-alkylammonioalkylacrylate chlorides or methosulfates;
b.1) poly-N,N,N-tri-C₁-C₅-alkylammonioalkylmethacrylate chloride or methosulfate, preferably selected from the group consisting of
   poly-N,N,N-[3-(trimethylammonio)ethyl]methacrylate chloride,
   poly-N,N,N-[3-(trimethylammonio)propyl]methacrylate chloride,
   poly-N,N,N-[3-(trimethylammonio)butyl]methacrylate chloride,
   poly-N,N,N-[3-(methyldiethylammonio)propyl]methacrylate methosulfate, and mixtures of two or more of these poly-N,N,N-tri-C1-C5-alkylammonioalkylmethacrylate chlorides or methosulfates;
c.1) poly-N,N,N-tri-C₁-C₅-alkylammonioalkylacrylamide chloride or methosulfate, preferably selected from the group consisting of
   poly-N,N,N[3-(trimethylammonio)ethyl]acrylamide chloride,
   poly-N,N,N[3-(trimethylammonio)propyl]acrylamide chloride,
   poly-N,N,N[3-(trimethylammonio)butyl]acrylamide chloride,
   poly-N,N,N[3-(methyldiethylammonio)propyl]acrylamide chloride, and mixtures of two or more of these poly-N,N,N-tri-C₁-C₅-alkylammonioalkylacrylamide chlorides or methosulfates;
d.1) poly-N,N,N-tri-C₁-C₅-alkylammonioalkylmethacrylamide chloride or methosulfate, preferably selected from the group consisting of
   poly-N,N,N-[3-(trimethylammonio)ethyl]methacrylamide chloride,
   poly-N,N,N-[3-(trimethylammonio)propyl]methacrylamide chloride,
   poly-N,N,N-[3-(trimethylammonio)butyl]methacrylamide chloride,
   poly-N,N,N-[3-(methyldiethylammonio)propyl]methacrylamide chloride, and mixtures of two or more of these poly-N,N,N-tri-C₁-C₅-alkylammonioalkylmethacrylamide chlorides or methosulfates;
e.1) poly-N-3-methyl-1-vinylimidazolium chloride;
f.1) poly-[bis(2-chloroethyl) ether-alt-1,3-bis-(3-dimethylaminopropyl)urea], quaternized;
g.1) poly(dimethylamine-co-epichlorohydrin-co-ethylenediamine);
h.1) polydimethyldiallylammonium chloride; and
i.1) poly(dimethyldiallylammonium chloride-co-methyldiallylamine hydrochloride).

In one embodiment of the aqueous solution of a polyion complex, the polyanions are anionic polymers or copolymers present in the form of alkali metal salts, preferably selected from the group consisting of lithium salt, sodium salt and potassium salt, and/or ammonium salts, further preferably as sodium salts.

In a preferred embodiment of the aqueous solution of a polyion complex, the anionic polymers or copolymers include at least one at least one polycarboxylate ether (PCE), wherein the at least one PCE is preferably selected from the group consisting of poly(methacrylic acid-co-methacrylic acid-polyethylene glycol monomethyl ether ester), poly(maleic acid-co-methacrylic acid-polyethylene glycol monomethyl ether ester), poly(methacrylic acid-co-methacrylic acid-polyethylene glycol monomethyl ether amide),

poly(maleic acid-co-methacrylic acid-polyethylene glycol methyl ether ester),
poly(maleic acid-co-methacrylic acid-polyethylene glycol monomethyl ether amide),
poly(maleic acid-co-methacrylic acid-polyethylene glycol methylamide), poly(maleic acid-co-polyethylene glycol monoallyl ether-co-polyethylene glycol bismaleamide acid),
poly(methacrylic acid-co-polyethylene glycol methyl vinyl ether), poly(maleic acid-co-polyethylene glycol methyl vinyl ether), poly(methacrylic acid-co-polyethylene glycol methyl allyl ether), poly(methacrylic acid-co-polyethylene glycol methyl methallyl ether),
poly(maleic acid-co-polyethylene glycol methyl allyl ether), poly(maleic acid-co-polyethylene glycol methyl methallyl ether), poly(maleic acid-co-N,N-diallyl-N-methyl-N-polyethylene glycol monomethyl ether) and
poly(methacrylic acid-co-N,N-diallyl-N-methyl-N-polyethylene glycol),
wherein the polyethylene glycol (or polyethylene glycol methyl ether) radical in the above-listed anionic polymers is —[CH₂—CH₂—O]ₐ—H or —[CH₂—CH₂—O]ₐ—CH₃; wherein a denotes the degree of ethoxylation (number of monomeric repeat ethylene oxide units), wherein a is an integer in the range from 1 to 100; and wherein the negative charge is compensated in each case by one or more single charged cation(s), preferably one cation selected from the group consisting of sodium cation, potassium cation, ammonium cation and mixtures of two or more of these cations. Polycarboxylate ethers (PCEs) used are especially the alkali metal salts thereof, preferably the sodium salts thereof, further preferably selected from the group consisting of
poly(methacrylic acid-co-methacrylic acid-polyethylene glycol monomethyl ether ester),
poly(maleic acid-co-methacrylic acid-polyethylene glycol monomethyl ether ester),
poly(methacrylic acid-co-methacrylic acid-polyethylene glycol monomethyl ether amide),
poly(maleic acid-co-methacrylic acid-polyethylene glycol monomethyl ether ester),
poly(maleic acid-co-methacrylic acid-polyethylene glycol monomethyl ether amide),
poly(maleic acid-co-methacrylic acid-polyethylene glycol methylamide),
poly(maleic acid-co-polyethylene glycol monoallyl ether-co-polyethylene glycol bismaleamide acid),
poly(methacrylic acid-co-polyethylene glycol methyl vinyl ether),
poly(maleic acid-co-polyethylene glycol methyl vinyl ether),
poly(methacrylic acid-co-polyethylene glycol methyl allyl ether),
poly(methacrylic acid-co-polyethylene glycol methyl methallyl ether),
poly(maleic acid-co-polyethylene glycol methyl allyl ether),
poly(maleic acid-co-polyethylene glycol methyl methallyl ether),
poly(maleic acid-co-N,N-diallyl-N-methyl-N-polyethylene glycol monomethyl ether) and
poly(methacrylic acid-co-N,N-diallyl-N-methyl-N-polyethylene glycol),
wherein the polyethylene glycol (or polyethylene glycol methyl ether) radical in the above-listed anionic polymers is —[CH₂-CH₂—O]ₐ—H or —[CH₂-CH₂—O]ₐ—CH₃; wherein a denotes the degree of ethoxylation (number of monomeric repeat ethylene oxide units), wherein a is an integer in the range from 1 to 100.

In one embodiment of the aqueous solution of a polyion complex, the polymers or copolymers further comprise one or more further polymers or copolymers selected from the group consisting of
m) poly(2-acrylamido-2-methylpropanesulfonate);
n) poly(p-styrenesulfonic acid);
o) poly(p-styrenesulfonic acid-co-maleic acid);
p) poly(dimethyldiallylammonium-co-acryloylhydroxamatobetaine) partially anionic;
q) poly(meth)acrylate;

r) poly(meth)acrylic acid crosslinked with pentaerythritol triallyl ether [≤0.5 mol %];
s) polymeric natural substances, modified to anionic polymers with alkali metal (especially sodium) chloroacetate or (hydrogen)sulfite, preferably selected from the group consisting of carboxymethylcellulose, carboxymethyl starch, lignosulfonate and mixtures of two or more of these modified polymeric natural substances; and
t) anionic inorganic polymers, preferably selected from the group consisting of hexametaphosphate (PO₃⁻)₆, Si₃O₇²⁻, and mixtures of two or more of these inorganic polymers;
   wherein the negative charge of the in each case is compensated by one or more singly charged cation(s), preferably one cation selected from the group consisting of sodium cation, potassium cation, ammonium cation and mixtures of two or more of these cations.

The further polymers or copolymer are preferably selected from the group consisting of:
m.1) poly(2-acrylamido-2-methylpropanesulfonate) sodium salt;
n.1) poly(p-styrenesulfonic acid) ammonium salt;
o.1) poly(p-styrenesulfonic acid-co-maleic acid) sodium salt;
p.1) poly(dimethyldiallylammonium-co-acryloylhydroxamatobetaine) partial ammonium salt,
q.1) sodium or potassium salts of poly(meth)acrylate;
r.1) poly(meth)acrylic acid crosslinked with pentaerythritol triallyl ether [≤0.5 mol %] and partially neutralized with sodium hydroxide or potassium hydroxide solution to give sodium or potassium salts;
s.1) polymeric natural substances, modified to anionic polymers with sodium chloroacetate, selected from the group consisting of carboxymethylcellulose sodium salt, carboxymethylstarch sodium salt, lignosulfonate sodium salt and mixtures of two or more of these polymeric natural substances; and
t.1) anionic inorganic polymers, selected from the group consisting of
   sodium hexametaphosphate (NaPO₃)₆,
   sodium silicate Na₂Si₃O₇,
   potassium silicate K₂O.nSiO₂,
   lithium polysilicate Li₂O.5SiO₂ and mixtures of two or more of these inorganic polymers.

In one embodiment of the aqueous solution of a polyion complex, the polyion complex further comprises one or more nonionic water-soluble monomers, preferably selected from the group consisting of N-vinyllactam, carboxamide and carbonic acid derivative, further preferably from the group consisting of N-vinylpyrrolidone, N-vinylpiperidone, N-vinylcaprolactam and N-vinylformamide,

N-vinyl acetamide, N-methyl-N-vinylacetamide, acrylamide, methacrylamide, N,N-dimethylacrylamide, N,N-dimethylmethacrylamide, N-methylolmethacrylamide, N-hydroxyethylmethacrylamide, N-hydroxypropylmethacrylamide, vinyl acetate, acrylonitrile and C₁ to C₆-alkyl ethylene glycol (meth)acrylate having 1 to 80 monomeric repeat ethylene oxide units in the ethylene glycol radical.

In a preferred embodiment of the aqueous solution of a polyion complex, the polyion complex has the general formula (I)

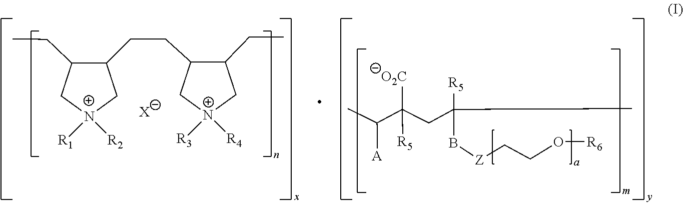

wherein:
R₁, R₂ are independently selected from the group consisting of hydrogen atom, C₁ to C₁₈-alkyl radical, polyethylene glycol radical —[CH₂—CH₂—O]ₐ—H, and polyethylene glycol methyl ether radical —[CH₂—CH₂—O]ₐ—CH₃, wherein a is an integer in the range from 1 to 100;
X⁻ is a halide anion or methosulfate anion, preferably a chloride anion;
R₃, R₄:
   are either independently selected from the group consisting of hydrogen atom, C₁ to C₁₈-alkyl radical, polyethylene glycol radical —[CH₂—CH₂—O]ₐ—H, and polyethylene glycol C₁ to C₁₈-alkyl ether radical, preferably —[CH₂—CH₂—O]ₐ—CH₃, wherein a is an integer in the range from 1 to 100;
   or
   represent a radical of the general formula (II)

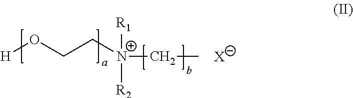

wherein X⁻, R₁, R₂ and a have the definitions given above for the general formula (II), b is 2 or 3;
   or
   represent a radical of the general formula (III)

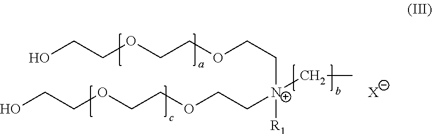

in which X⁻, R₁, a and b have the definitions given above for the general formula (II) or (III) and c is an integer in the range from
   1 to 100;
R₅ is a hydrogen atom or a methyl group;
R₆ is a hydrogen atom or a C₁ to C₁₈-alkyl radical, preferably a methyl group;
A is a hydrogen atom, a carboxylate anion —CO₂⁻ or a carboxylate sodium —CO₂Na,
B is a methylene group —CH₂— or a carbonyl group —CO—, or the bridge group is absent,
Z is an oxygen atom or a nitrogen radical NR₆ with the definition already given for R₆;
n, m are independently either the same or different and denote the degree of polymerization that represents the number of monomeric repeat units in the polymer,
x, y are numbers from the range from 1 to 100, where, preferably, x≥y or x≤y.

In one embodiment of the aqueous solution of a polyion complex, the polyion complex is in aqueous solution, wherein preferably >90% by weight of the aqueous solution of the polyion complex consists of polyion complex and water.

In one embodiment of the aqueous solution of a polyion complex, the aqueous solution of the polyion complex preferably comprises more than 10% by weight, preferably more than 20% by weight, further preferably more than 50% by weight, of water, based on the total weight of the respective aqueous solution.

In one embodiment of the aqueous solution of a polyion complex, the aqueous solution of the polyion complex comprises 0.01% to 5.0% by weight, preferably 0.1% to 3.0% by weight, of polyion complex, based on the total weight of the respective aqueous solution.

In one embodiment of the aqueous solution of a polyion complex, the aqueous solution of the polyion complex has a pH in the range from 6 to 9.

### Use of a Polyion Complex

The invention further relates to the use of a polyion complex, especially an aqueous solution of a polyion complex, wherein the polyion complex comprises x mol of polycations and y mol of polyanions, wherein x and y are each integers from the range from 1 to 100 and x≤y or x≥y, according to any of embodiments 1 to 14 or 30 to 42 for surface modification, especially surface hydrophilization, of polymer fibers and/or carbon fibers.

What is meant by “surface modification”, especially “surface hydrophilization”, is that a previously hydrophobic surface, i.e. one that was not wettable in an aqueous medium, is converted to one that is wettable thereafter. A hydrophobic surface means a surface having a contact angle of >90° when wetted with water. What is meant by “wettable”, i.e. hydrophilic surface, is that the surface has a contact angle of ≤90° when wetted with water. Contact angle (synonym: wetting angle) refers to the angle formed by a liquid droplet, especially a water droplet, to the surface of a solid with respect to this surface. Surface-modified, especially surface-hydrophilized, polymer fibers and/or carbon fibers have the property that the polymer fibers and/or carbon fibers are wettable and individualizable in an aqueous medium. Accordingly, the surface of the surface-modified, especially surface-hydrophilized, polymer fibers and/or carbon fibers has a contact angle of ≤90° when wetted with water.

In one embodiment of the use the polyion complex, the polymer fibers are selected from the group of thermoplastic polymer fibers, preferably selected from the group consisting of polyacrylonitrile fibers, polyester fibers, polyurethane fibers, polyamide fibers, polyvinylalcohol fibers, polyethylene fibers, polypropylene fibers and mixtures of two or more of these polymer fibers, further preferably from the group consisting of polyacrylonitrile fibers, polypropylene fibers and mixtures of two or more of these polymer fibers. Polymer fibers, carbon fibers or mixtures of polymer fibers and carbon fibers are used.

In one embodiment of the use of the polyion complex, the polymer fibers or carbon fibers have a fiber length of 2 to 16 mm, preferably 6 to 8 mm, and a fiber diameter of 5 to 120 μm, preferably of 7 to 15.4 μm.

The polymer fibers and/or carbon fibers preferably have an (apparent) density in the range from 0.1 to 5 g/cm³, further preferably in the range from 0.5 to 2 g/cm³, further preferably in the range from 0.8 to 1.2 g/cm³.

Process For Surface Modification of Polymer Fibers and/or Carbon Fibers

The invention likewise relates to a process for surface modification, especially surface hydrophilization, of polymer fibers and/or carbon fibers, comprising:
a) providing polymer fibers and/or carbon fibers;
b) providing an aqueous solution of a polyion complex, wherein the polyion complex comprises x mol of polycations and y mol of polyanions, wherein x and y are each integers from the range from 1 to 100 and x≤y or x≥y;
c) mixing the polymer fibers and/or carbon fibers provided in (a) and the aqueous solution of the polyion complex from (b) to obtain an aqueous mixture comprising surface-modified polymer fibers and/or carbon fibers;
d) separating the surface-modified polymer fibers and/or carbon fibers from the aqueous mixture in (c) (filtering, sieving, decanting) to obtain wet surface-modified polymer fibers and/or carbon fibers having a water content of 0.1% to 50% by weight, preferably between 5% and 40% by weight (wet fibers);
e) compacting, especially mechanically compacting on the industrial scale, for example with the aid of a roll mill, or on the laboratory scale, for example with the aid of a plunger, the wet fibers obtained in (d) to obtain compacted wet fibers, for example in the form of a compact, i.e. compacted, felt layer of layer height 1 to 10 mm;
f) optionally drying the surface-modified polymer fibers and/or carbon fibers separated in (d) or the wet fibers compacted in (e), preferably at a temperature in the range from 5 to 70° C., preferably 15 to 30° C.

This procedure, by virtue of compaction of the polymer fibers and/or carbon fibers, offers the further advantage that the distances between the adjacent fibers are very small and the onset of action of the capillary forces via the cavities between the fibers permits more complete wetting or better finishing of the fiber surfaces with the treatment agent solution, which is in turn a necessary prerequisite for later spontaneous fiber individualization.

By virtue of this preferred embodiment of the process of the invention, such finished wet fibers are in an effectively “preswollen hydrophilic (surface) state” that permits spontaneous individualization of the fibers on contact with an aqueous medium without delay. “Wet fibers” here includes correspondingly modified polymer fibers, carbon fibers and mixtures of polymer fibers and carbon fibers.

By contrast, fibers that have been modified in an aqueous medium and subsequently dried, or those that have been pretreated with finish (surfactants), as is common practice, need more time for a comprehensive and penetrating swelling operation in order to be distributed.

This is particularly problematic when, for example, in a concrete or mortar system to be modified with fibers, only little water and time is available for fiber distribution; consequently, complete fiber distribution is barely possible or difficult to achieve.

A preferred concentration of the polyion complex in the aqueous solution of a polyion complex provided in (b), for example in the case of use according to examples 1 to 12, is in the range from 1.0% to 10.0% by weight, preferably in the range from 2.0% to 5.0% by weight, based in each case on 100% by weight of the amount of fibers used.

In one embodiment of the process for surface modification, especially surface hydrophilization, of polymer fibers and/or carbon fibers, at least one interface-active compound is also added to the aqueous solution of a polyion complex from (a), preferably at least one interface-active compound selected from the group of the interface-active compounds based on modified castor oil, further preferably selected from the group of the ricinoleic acid polyethylene glycol esters, further preferably selected from the group of the ricinoleic acid polyethylene glycol esters having 10 to 50 repeat ethylene oxide units.

The invention further relates to surface-modified, especially hydrophilized, polymer fibers and/or carbon fibers, obtained or obtainable by the process described above, preferably obtained or obtainable in step (d) (wet fibers) or (e) (compacted wet fibers), further preferably obtained or obtainable in step (e) (compacted wet fibers).

Surface-Modified Polymer Fibers and/or Carbon Fibers

The invention also relates to surface-modified, especially hydrophilized, polymer fibers and/or carbon fibers having a coating based on a polyion complex on at least part of the polymer fiber or carbon fiber surface, preferably over the entire polymer fiber or carbon fiber surface, wherein the polyion complex comprises x mol of polycations and y mol of polyanions, wherein x and y are each integers from the range from 1 to 100 and x≤y or x≥y; preferably based on a polyion complex as described at the outset.

A “coating on at least a portion of the polymer fiber or carbon fiber surface or over the entire polymer fiber or carbon fiber surface” is understood to mean that a polyionically crosslinked, hydrophilic modifying active ingredient—the polyion complex of the invention here—is adsorbed (automatically) on the polymer fiber or carbon fiber surface and additionally physically adheres to and at least partly, preferably completely, envelops the polymer fiber or carbon fiber surface for structure-related reasons by virtue of the ionic charge carriers.

Complete enveloping is understood to mean that the polymer fiber or carbon fiber surface is coated to an extent of at least 95%, preferably to an extent of at least 99%.

Use of Surface-Modified Polymer Fibers and/or Carbon Fibers

The invention further relates to the use of surface-modified, especially hydrophilized, polymer fibers and/or carbon fibers as described above or of surface-modified, especially hydrophilized, polymer fibers and/or carbon fibers obtained or obtainable by the process described above for production of fiber-modified building materials, preferably fiber-modified gypsum, concrete or mortar systems.

“Building material” means binder-based building materials, wherein the “binder” is preferably selected from the group of the mineral binders, further preferably from the group consisting of slaked lime, gypsum, cement and mixtures of two or more of these mineral binders.

A preferred concentration of surface-modified, especially hydrophilized, polymer fibers or carbon fiber fibers, is between 0.03% and 1.2% by volume, preferably 0.06% to 0.5% by volume, based in each case on 100% by volume of the overall mixture of mineral binders.

### Fiber-Modified Building Material

The invention further relates to a fiber-modified building material, especially a fiber-modified gypsum, concrete or mortar system, comprising surface-modified, especially hydrophilized, polymer fibers and/or carbon fibers as described above or surface-modified, especially hydrophilized, polymer fibers and/or carbon fibers obtained or obtainable by the process described above.

The present invention is illustrated in detail by the following embodiments and combinations of embodiments that result from the corresponding (dependency) references:
1. A polyion complex comprising x mol of polycations and y mol of polyanions, especially for individualization of polymer fibers, wherein x and y are each integers from the range from 1 to 100 and x≤y or x≥y.
2. A polyion complex according to embodiment 1, wherein the polycations are cationic polymers or copolymers, preferably cationic polymers or copolymers having at least one quaternary ammonium cation and further preferably selected from the group consisting of
   a) poly-N,N,N-tri-C₁-C₅-alkylammonioalkyl acrylate, wherein the poly-N,N,N-tri-C₁-C₅-alkylammonioalkyl acrylate is preferably selected from the group consisting of poly-N,N,N-[3-(trimethylammonio)ethyl] acrylate, poly-N,N,N-[3-(trimethylammonio)propyl] acrylate, poly-N,N,N-[3-(trimethylammonio)butyl] acrylate, poly-N,N,N-[3-(methyldiethylammonio)propyl] acrylate and mixtures of two or more of these poly-N,N,N-tri-C₁-C₅-alkylammonioalkyl acrylates;
   b) poly-N,N,N-tri-C₁-C₅-alkylammonioalkyl methacrylate, wherein the poly-N,N,N-tri-C₁-C₅-alkylammonioalkyl methacrylate is preferably selected from the group consisting of poly-N,N,N-[3-(trimethylammonio)ethyl] methacrylate, poly-N,N,N-[3(trimethylammonio)propyl] methacrylate, poly-N,N,N-[3-(trimethylammonio)butyl] methacrylate, poly-N,N,N[3-(methyldiethylammonio)propyl] methacrylate and mixtures of two or more of these poly-N,N,N-tri-C₁-C₅-alkylammonioalkyl methacrylates;
   c) poly-N,N,N-tri-C1-C5-alkylammonioalkylacrylamide, wherein the poly-N,N,N-tri-C₁-C₅-alkylammonioalkylacrylamide is preferably selected from the group consisting of poly-N,N,N[3-(trimethylammonio)ethyl]acrylamide, poly-N,N,N-[3-(trimethylammonio)propyl]acrylamide, poly-N,N,N-[3-(trimethylammonio)butyl]acrylamide, poly-N,N,N-[3-(methyldiethylammonio)propyl]acrylamide and mixtures of two or more of these poly-N,N,N-tri-C₁-C₅-alkylammonioalkylacrylamides;
   d) poly-N,N,N-tri-C₁-C₅-alkylammonioalkylmethacrylamide, wherein the poly-N,N,N-tri-C₁-C₅-alkylammonioalkylmethacrylamide is preferably selected from the group consisting of poly-N,N,N-[3-(trimethylammonio)ethyl]methacrylamide, poly-N,N,N-[3-(trimethylammonio)propyl]methacrylamide, poly-N,N,N-[3-(trimethylammonio)butyl]methacrylamide, poly-N,N,N-[3-(methyldiethylammonio)propyl]methacrylamide and mixtures of two or more of these poly-N,N,N-tri-C₁-C₅-alkylammonioalkylmethacrylamides;
   e) poly-N-3-methyl-1-vinylimidazolium;
   f) quaternized poly [bis(2-chloroethyl) ether-alt-1,3-bis-(3-dimethylamino-propyl)urea];
   g) poly(dimethylamine-co-epichlorohydrin-co-ethylenediamine);
   h) polydimethyldiallylammonium; and
   i) poly(dimethyldiallylammonium-co-methyldiallylamine hydrochloride);
      wherein the positive charge of the nitrogen atom of the quaternary ammonium cation is compensated by a singly charged anion, preferably an anion selected from the group consisting of halide anions, especially chloride anion, methosulfate anion, ethosulfate anion and mixtures of two or more of these anions.
3. A polyion complex according to embodiment 1 or 2, wherein the polycations are cationic polymers or copolymers having at least one quaternary ammonium cation and selected from the group consisting of
   a.1) poly-N,N,N-tri-C₁-C₅-alkylammonioalkylacrylate chloride or methosulfate, preferably selected from the group consisting of
      poly-N,N,N-[3-(trimethylammonio)ethyl]acrylate chloride,
   poly-N,N,N-[3-(trimethylammonio)propyl]acrylate chloride,
   poly-N,N,N-[3-(trimethylammonio)butyl]acrylate chloride,
   poly-N,N,N-[3-(methyldiethylammonio)propyl]acrylate methosulfate, and mixtures of two or more of these poly-N,N,N-tri-C₁-C₅-alkylammonioalkylacrylate chlorides or methosulfates;
   b.1) poly-N,N,N-tri-C₁-C₅-alkylammonioalkylmethacrylate chloride or methosulfate, preferably selected from the group consisting of
      poly-N,N,N-[3-(trimethylammonio)ethyl]methacrylate chloride,
      poly-N,N,N-[3-(trimethylammonio)propyl]methacrylate chloride,
      poly-N,N,N-[3-(trimethylammonio)butyl]methacrylate chloride,
      poly-N,N,N-[3-(methyldiethylammonio)propyl]methacrylate methosulfate, and mixtures of two or more of these poly-N,N,N-tri-C1-C5-alkylammonioalkylmethacrylate chlorides or methosulfates;
   c.1) poly-N,N,N-tri-C₁-C₅-alkylammonioalkylacrylamide chloride or methosulfate, preferably selected from the group consisting of
      poly-N,N,N[3-(trimethylammonio)ethyl]acrylamide chloride,
      poly-N,N,N[3-(trimethylammonio)propyl]acrylamide chloride,
      poly-N,N,N[3-(trimethylammonio)butyl]acrylamide chloride,
      poly-N,N,N[3-(methyldiethylammonio)propyl]acrylamide chloride, and mixtures of two or more of these poly-N,N,N-tri-C₁-C₅-alkylammonioalkylacrylamide chlorides or methosulfates;
   d.1) poly-N,N,N-tri-C₁-C₅-alkylammonioalkylmethacrylamide chloride or methosulfate,
      preferably selected from the group consisting of
      poly-N,N,N-[3-(trimethylammonio)ethyl]methacrylamide chloride,
      poly-N,N,N-[3-(trimethylammonio)propyl]methacrylamide chloride,
      poly-N,N,N-[3-(trimethylammonio)butyl]methacrylamide chloride,
      poly-N,N,N-[3-(methyldiethylammonio)propyl]methacrylamide chloride, and mixtures of two or more of these poly-N,N,N-tri-C₁-C₅-alkylammonioalkylmethacrylamide chlorides or methosulfates;
   e.1) poly-N-3-methyl-1-vinylimidazolium chloride;
   f.1) poly-[bis(2-chloroethyl) ether-alt-1,3-bis-(3-dimethylaminopropyl)urea], quaternized;
   g.1) poly(dimethylamine-co-epichlorohydrin-co-ethylenediamine);
   h.1) polydimethyldiallylammonium chloride; and
   i.1) poly(dimethyldiallylammonium chloride-co-methyldiallylamine hydrochloride).
4. A polyion complex according to any of embodiments 1 to 3, wherein the polyanions are anionic polymers or copolymers present in the form of alkali metal salts, preferably selected from the group consisting of lithium salt, sodium salt and potassium salt, and/or ammonium salts, further preferably as sodium salts.
5. A polyion complex according to embodiment 4, wherein the anionic polymers or copolymers include at least one at least one polycarboxylate ether (PCE), wherein the at least one PCE is preferably selected from the group consisting of poly(methacrylic acid-co-methacrylic acid-polyethylene glycol monomethyl ether ester), poly(maleic acid-co-methacrylic acid-polyethylene glycol monomethyl ether ester), poly(methacrylic acid-co-methacrylic acid-polyethylene glycol monomethyl ether amide),
   poly(maleic acid-co-methacrylic acid-polyethylene glycol methyl ether ester),
   poly(maleic acid-co-methacrylic acid-polyethylene glycol monomethyl ether amide),
   poly(maleic acid-co-methacrylic acid-polyethylene glycol methylamide), poly(maleic acid-co-polyethylene glycol monoallyl ether-co-polyethylene glycol bismaleamide acid), poly(methacrylic acid-co-polyethylene glycol methyl vinyl ether), poly(maleic acid-co-polyethylene glycol methyl vinyl ether), poly(methacrylic acid-co-polyethylene glycol methyl allyl ether), poly(methacrylic acid-co-polyethylene glycol methyl methallyl ether), poly(maleic acid-co-polyethylene glycol methyl allyl ether),
   poly(maleic acid-co-polyethylene glycol methyl methallyl ether), poly(maleic acid-co-N,N-diallyl-N-methyl-N-polyethylene glycol monomethyl ether) and
   poly(methacrylic acid-co-N,N-diallyl-N-methyl-N-polyethylene glycol),
   wherein the polyethylene glycol (or polyethylene glycol methyl ether) radical in the above-listed anionic polymers is —[CH₂—CH₂—O]ₐ—H or —[CH₂—CH₂—O]ₐ—CH₃; wherein a denotes the degree of ethoxylation (number of monomeric repeat ethylene oxide units), wherein a is an integer in the range from 1 to 100; and wherein the negative charge is compensated in each case by one or more single charged cation(s), preferably one cation selected from the group consisting of sodium cation, potassium cation, ammonium cation and mixtures of two or more of these cations.
6. A polyion complex according to embodiment 5, wherein the polycarboxylate ethers (PCEs) used are especially the alkali metal salts thereof, preferably the sodium salts thereof, further preferably selected from the group consisting of
   poly(methacrylic acid-co-methacrylic acid-polyethylene glycol monomethyl ether ester),
   poly(maleic acid-co-methacrylic acid-polyethylene glycol monomethyl ether ester),
   poly(methacrylic acid-co-methacrylic acid-polyethylene glycol monomethyl ether amide),
   poly(maleic acid-co-methacrylic acid-polyethylene glycol methyl ether ester),
   poly(maleic acid-co-methacrylic acid-polyethylene glycol monomethyl ether amide),
   poly(maleic acid-co-methacrylic acid-polyethylene glycol methylamide),
   poly(maleic acid-co-polyethylene glycol monoallyl ether-co-polyethylene glycol bismaleamide acid),
   poly(methacrylic acid-co-polyethylene glycol methyl vinyl ether),
   poly(maleic acid-co-polyethylene glycol methyl vinyl ether),
   poly(methacrylic acid-co-polyethylene glycol methyl allyl ether),
   poly(methacrylic acid-co-polyethylene glycol methyl methallyl ether),
   poly(maleic acid-co-polyethylene glycol methyl allyl ether),
   poly(maleic acid-co-polyethylene glycol methyl methallyl ether),
   poly(maleic acid-co-N,N-diallyl-N-methyl-N-polyethylene glycol monomethyl ether) and
   poly(methacrylic acid-co-N,N-diallyl-N-methyl-N-polyethylene glycol),
   wherein the polyethylene glycol (or polyethylene glycol methyl ether) radical in the above-listed anionic polymers is —[CH₂—CH₂—O]ₐ—H or —[CH₂—CH₂—O]ₐ—CH₃; wherein a denotes the degree of ethoxylation (number of monomeric repeat ethylene oxide units), wherein a is an integer in the range from 1 to 100.
7. A polyion complex according to embodiment 5 or 6, wherein the anionic polymers or copolymers further comprise one or more further polymers or copolymers selected from the group consisting of
   m) poly(2-acrylamido-2-methylpropansulfonate);
   n) poly(p-styrenesulfonic acid);
   o) poly(p-styrenesulfonic acid-co-maleic acid);
   p) poly(dimethyldiallylammonium-co-acryloylhydroxamatobetaine) partially anionic;
   q) poly(meth)acrylate;
   r) poly(meth)acrylic acid crosslinked with pentaerythritol triallyl ether [≤0.5 mol %];
   s) polymeric natural substances, modified to anionic polymers with alkali metal (especially sodium) chloroacetate or (hydrogen)sulfite, preferably selected from the group consisting of carboxymethylcellulose, carboxymethylstarch, lignosulfonate and mixtures of two or more of these modified polymeric natural substances; and
   t) anionic inorganic polymers, preferably selected from the group consisting of hexametaphosphate (PO₃⁻)₆, silicate Si₃O₇²⁻, and mixtures of two or more of these inorganic polymers;
      wherein the negative charge of the in each case is compensated by one or more singly charged cation(s), preferably one cation selected from the group consisting of sodium cation, potassium cation, ammonium cation and mixtures of two or more of these cations.
8. A polyion complex according to embodiment 7, wherein the further polymers or copolymer are selected from the group consisting of
   m.1) poly(2-acrylamido-2-methylpropanesulfonate) sodium salt;
   n.1) poly(p-styrenesulfonic acid) ammonium salt;
   o.1) poly(p-styrenesulfonic acid-co-maleic acid) sodium salt;
   p.1) poly(dimethyldiallylammonium-co-acryloylhydroxamatobetaine) partial ammonium salt,
   q.1) sodium or potassium salts of poly(meth)acrylate;
   r.1) poly(meth)acrylic acid crosslinked with pentaerythritol triallyl ether [≤0.5 mol %] and partially neutralized with sodium hydroxide or potassium hydroxide solution to give sodium or potassium salts;
   s.1) polymeric natural substances, modified to anionic polymers with sodium chloroacetate, selected from the group consisting of carboxymethylcellulose sodium salt, carboxymethylstarch sodium salt, lignosulfonate sodium salt and mixtures of two or more of these polymeric natural substances; and
   t.1) anionic inorganic polymers, selected from the group consisting of sodium hexametaphosphate (NaPO₃)₆, sodium silicate Na₂Si₃O₇, potassium silicate K₂O.nSiO₂, lithium polysilicate Li₂O.5SiO₂ and mixtures of two or more of these inorganic polymers.
9. A polyion complex according to any of embodiments 1 to 8, further comprising one or more nonionic water-soluble monomers, preferably selected from the group consisting of N-vinyllactam, carboxamide and carbonic acid derivative, further preferably from the group consisting of N-vinylpyrrolidone, N-vinylpiperidone, N-vinylcaprolactam and N-vinylformamide,
   N-vinylacetamide, N-methyl-N-vinylacetamide, acrylamide, methacrylamide, N,N-dimethylacrylamide, N,N-dimethylmethacrylamide, N-methylolmethacrylamide, N-hydroxyethylmethacrylamide, N-hydroxypropylmethacrylamide, vinyl acetate, acrylonitrile and C₁ to C₆-alkyl ethylene glycol (meth)acrylate having 1 to 80 monomeric repeat ethylene oxide units in the ethylene glycol radical.
10. A polyion complex according to any of embodiments 1 to 9, wherein the polyion complex has the general formula (I)

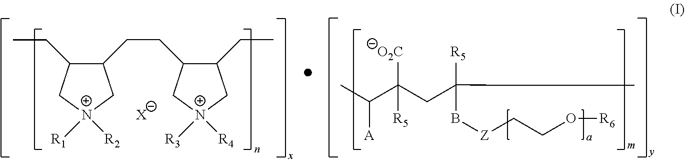

wherein:
R₁, R₂ are independently selected from the group consisting of hydrogen atom, C₁ to C₁₈-alkyl radical, polyethylene glycol radical —[CH₂—CH₂—O]ₐ—H, and polyethylene glycol methyl ether radical —[CH₂—CH₂—O]ₐ—CH₃, wherein a is an integer in the range from 1 to 100;
X⁻ is a halide anion or methosulfate anion, preferably a chloride anion;
R₃, R₄:
   are either independently selected from the group consisting of hydrogen atom, C₁ to C₁₈-alkyl radical, polyethylene glycol radical —[CH₂—CH₂—O]ₐ—H, and polyethylene glycol C₁ to C₁₈-alkyl ether radical, preferably —[CH₂—CH₂—O]ₐ—CH₃, wherein a is an integer in the range from 1 to 100;
   or
   represent a radical of the general formula (II)

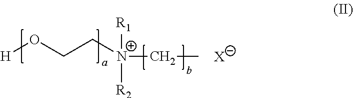

wherein X⁻, R₁, R₂ and a have the definitions given above for the general formula (II), b is 2 or 3;
   or
   represent a radical of the general formula (III)

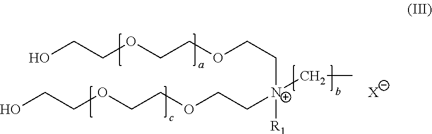

in which X⁻, R₁, a and b have the definitions given above for the general formula (II) or (III) and c is an integer in the range from
   1 to 100;
R₅ is a hydrogen atom or a methyl group;
R₆ is a hydrogen atom or a C₁ to C₁₈-alkyl radical, preferably a methyl group;
A is a hydrogen atom, a carboxylate anion —CO₂⁻ or a carboxylate sodium —CO₂Na,
B is a methylene group —CH₂— or a carbonyl group —CO—, or the bridge group is absent,
Z is an oxygen atom or a nitrogen radical NR₆ with the definition already given for R₆;
n, m are independently either the same or different and denote the degree of polymerization that represents the number of monomeric repeat units in the polymer,
x, y are numbers from the range from 1 to 100, where, preferably, x≥y or x≤y.
11. A polyion complex according to any of embodiments 1 to 10, wherein the polyion complex is in aqueous solution, wherein preferably ≥90% by weight of the aqueous solution of the polyion complex consists of polyion complex and water.
12. A polyion complex according to embodiment 11, wherein the aqueous solution of the polyion complex comprises more than 10% by weight, preferably more than 20% by weight, further preferably more than 50% by weight, of water, based on the total weight of the respective aqueous solution.
13. A polyion complex according to embodiment 11 or 12, wherein the aqueous solution of the polyion complex has a pH in the range from 6 to 9.
14. A process for preparing a polyion complex, especially an aqueous solution of a polyion complex, wherein the polyion complex comprises x mol of polycations and y mol of polyanions, wherein x and y are each integers from the range from 1 to 100 and x≤y or x≥y, comprising:
   1) providing an aqueous solution of a polycation component or an aqueous solution of a polyanion component;
   2) adding an aqueous solution of a polyanion component or an aqueous solution of a polycation component to the aqueous solution of the polycation component or of the polyanion component provided in (1);
   to obtain an aqueous solution of a polyion complex.
15. The process for preparing a polyion complex according to embodiment 14, wherein the addition in step (2) is effected at a temperature in the range from 0° C. to 50° C., preferably between 15° C. and 30° C.
16. The process for preparing a polyion complex according to embodiment 14 or 15, wherein the aqueous solution of the polyanion component comprises further additions selected from the group consisting of neutralizing agents, preferably selected from the group consisting of potassium carbonate, sodium carbonate, sodium hydroxide solution, potassium hydroxide solution or mixtures of two or more of these neutralizing agents; extra added electrolyte, preferably sodium chloride; surfactant, preferably sodium lauryl ether sulfate; and mixtures of two or more of these additions.
17. The process for preparing a polyion complex according to either of embodiments 15 and 16, wherein the polycations are cationic polymers or copolymers, preferably cationic polymers or copolymers having at least one quaternary ammonium cation and further preferably selected from the group consisting of
   a) poly-N,N,N-tri-C₁-C₅-alkylammonioalkyl acrylate, wherein the poly-N,N,N-tri-C₁-C₅-alkylammonioalkyl acrylate is preferably selected from the group consisting of poly-N,N,N-[3-(trimethylammonio)ethyl] acrylate, poly-N,N,N-[3-(trimethylammonio)propyl] acrylate, poly-N,N,N-[3-(trimethylammonio)butyl] acrylate, poly-N,N,N-[3-(methyldiethylammonio)propyl] acrylate and mixtures of two or more of these poly-N,N,N-tri-C₁-C₅-alkylammonioalkyl acrylates;
   b) poly-N,N,N-tri-C₁-C₅-alkylammonioalkyl methacrylate, wherein the poly-N,N,N-tri-C₁-C₅-alkylammonioalkyl methacrylate is preferably selected from the group consisting of poly-N,N,N-[3-(trimethylammonio)ethyl] methacrylate, poly-N,N,N-[3(trimethylammonio)propyl] methacrylate, poly-N,N,N-[3-(trimethylammonio)butyl] methacrylate, poly-N,N,N[3-(methyldiethylammonio)propyl] methacrylate and mixtures of two or more of these poly-N,N,N-tri-C₁-C₅-alkylammonioalkyl methacrylates;
   c) poly-N,N,N-tri-C1-C5-alkylammonioalkylacrylamide, wherein the poly-N,N,N-tri-C₁-C₅-alkylammonioalkylacrylamide is preferably selected from the group consisting of poly-N,N,N[3-(trimethylammonio)ethyl]acrylamide, poly-N,N,N-[3-(trimethylammonio)propyl]acrylamide, poly-N,N,N-[3-(trimethylammonio)butyl]acrylamide, poly-N,N,N-[3-(methyldiethylammonio)propyl]acrylamide and mixtures of two or more of these poly-N,N,N-tri-C₁-C₅-alkylammonioalkylacrylamides;
   d) poly-N,N,N-tri-C₁-C₅-alkylammonioalkylmethacrylamide, wherein the poly-N,N,N-tri-C₁-C₅-alkylammonioalkylmethacrylamide is preferably selected from the group consisting of poly-N,N,N-[3-(trimethylammonio)ethyl]methacrylamide, poly-N,N,N-[3-(trimethylammonio)propyl]methacrylamide, poly-N,N,N-[3-(trimethylammonio)butyl]methacrylamide, poly-N,N,N-[3-(methyldiethylammonio)propyl]methacrylamide and mixtures of two or more of these poly-N,N,N-tri-C₁-C₅-alkylammonioalkylmethacrylamides;
   e) poly-N-3-methyl-1-vinylimidazolium;
   f) quaternized poly [bis(2-chloroethyl) ether-alt-1,3-bis-(3-dimethylamino-propyl)urea];
   g) poly(dimethylamine-co-epichlorohydrin-co-ethylenediamine);
   h) polydimethyldiallylammonium; and
   i) poly(dimethyldiallylammonium-co-methyldiallylamine hydrochloride);
      wherein the positive charge of the nitrogen atom of the quaternary ammonium cation is compensated by a singly charged anion, preferably an anion selected from the group consisting of halide anions, especially chloride anion, methosulfate anion, ethosulfate anion and mixtures of two or more of these anions.
18. The process for preparing a polyion complex according to embodiment 17, wherein the polycations are preferably cationic polymers or copolymers having at least one quaternary ammonium cation and selected from the group consisting of
   a.1) poly-N,N,N-tri-C₁-C₅-alkylammonioalkylacrylate chloride or methosulfate, preferably selected from the group consisting of
      poly-N,N,N-[3-(trimethylammonio)ethyl]acrylate chloride,
   poly-N,N,N-[3-(trimethylammonio)propyl]acrylate chloride,
   poly-N,N,N-[3-(trimethylammonio)butyl]acrylate chloride,
   poly-N,N,N-[3-(methyldiethylammonio)propyl]acrylate methosulfate, and mixtures of two or more of these poly-N,N,N-tri-C₁-C₅-alkylammonioalkylacrylate chlorides or methosulfates;
   b.1) poly-N,N,N-tri-C₁-C₅-alkylammonioalkylmethacrylate chloride or methosulfate, preferably selected from the group consisting of
      poly-N,N,N-[3-(trimethylammonio)ethyl]methacrylate chloride,
      poly-N,N,N-[3-(trimethylammonio)propyl]methacrylate chloride,
      poly-N,N,N-[3-(trimethylammonio)butyl]methacrylate chloride,
      poly-N,N,N-[3-(methyldiethylammonio)propyl]methacrylate methosulfate, and mixtures of two or more of these poly-N,N,N-tri-C1-C5-alkylammonioalkylmethacrylate chlorides or methosulfates;
   c.1) poly-N,N,N-tri-C₁-C₅-alkylammonioalkylacrylamide chloride or methosulfate, preferably selected from the group consisting of
      poly-N,N,N[3-(trimethylammonio)ethyl]acrylamide chloride,
      poly-N,N,N[3-(trimethylammonio)propyl]acrylamide chloride,
      poly-N,N,N[3-(trimethylammonio)butyl]acrylamide chloride,
      poly-N,N,N[3-(methyldiethylammonio)propyl]acrylamide chloride, and mixtures of two or more of these poly-N,N,N-tri-C₁-C₅-alkylammonioalkylacrylamide chlorides or methosulfates;
   d.1) poly-N,N,N-tri-C₁-C₅-alkylammonioalkylmethacrylamide chloride or methosulfate,
      preferably selected from the group consisting of
      poly-N,N,N-[3-(trimethylammonio)ethyl]methacrylamide chloride,
      poly-N,N,N-[3-(trimethylammonio)propyl]methacrylamide chloride,
      poly-N,N,N-[3-(trimethylammonio)butyl]methacrylamide chloride,
      poly-N,N,N-[3-(methyldiethylammonio)propyl]methacrylamide chloride, and mixtures of two or more of these poly-N,N,N-tri-C₁-C₅-alkylammonioalkylmethacrylamide chlorides or methosulfates;
   e.1) poly-N-3-methyl-1-vinylimidazolium chloride;
   f.1) poly-[bis(2-chloroethyl) ether-alt-1,3-bis-(3-dimethylaminopropyl)urea], quaternized;
   g.1) poly(dimethylamine-co-epichlorohydrin-co-ethylenediamine);
   h.1) polydimethyldiallylammonium chloride; and
   i.1) poly(dimethyldiallylammonium chloride-co-methyldiallylamine hydrochloride).
19. The process for preparing a polyion complex according to any of embodiments 15 to 18, wherein the polyanions are anionic polymers or copolymers present in the form of alkali metal salts, preferably selected from the group consisting of lithium salt, sodium salt and potassium salt, and/or ammonium salts, further preferably as sodium salts.
20. The process for preparing a polyion complex according to any of embodiments 15 to 19, wherein the anionic polymers or copolymers include at least one at least one polycarboxylate ether (PCE), wherein the at least one PCE is preferably selected from the group consisting of poly(methacrylic acid-co-methacrylic acid-polyethylene glycol monomethyl ether ester), poly(maleic acid-co-methacrylic acid-polyethylene glycol monomethyl ether ester), poly(methacrylic acid-co-methacrylic acid-polyethylene glycol monomethyl ether amide),
   poly(maleic acid-co-methacrylic acid-polyethylene glycol methyl ether ester),
   poly(maleic acid-co-methacrylic acid-polyethylene glycol monomethyl ether amide),
   poly(maleic acid-co-methacrylic acid-polyethylene glycol methylamide), poly(maleic acid-co-polyethylene glycol monoallyl ether-co-polyethylene glycol bismaleamide acid), poly(methacrylic acid-co-polyethylene glycol methyl vinyl ether), poly(maleic acid-co-polyethylene glycol methyl vinyl ether), poly(methacrylic acid-co-polyethylene glycol methyl allyl ether), poly(methacrylic acid-co-polyethylene glycol methyl methallyl ether), poly(maleic acid-co-polyethylene glycol methyl allyl ether),
   poly(maleic acid-co-polyethylene glycol methyl methallyl ether), poly(maleic acid-co-N,N-diallyl-N-methyl-N-polyethylene glycol monomethyl ether) and
   poly(methacrylic acid-co-N,N-diallyl-N-methyl-N-polyethylene glycol),
   wherein the polyethylene glycol (or polyethylene glycol methyl ether) radical in the above-listed anionic polymers is —[CH₂—CH₂—O]ₐ—H or —[CH₂—CH₂—O]ₐ—CH₃; wherein a denotes the degree of ethoxylation (number of monomeric repeat ethylene oxide units), wherein a is an integer in the range from 1 to 100; and wherein the negative charge is compensated in each case by one or more single charged cation(s), preferably one cation selected from the group consisting of sodium cation, potassium cation, ammonium cation and mixtures of two or more of these cations.
21. The process for preparing a polyion complex according to any of embodiments 15 to 20, wherein the polycarboxylate ethers (PCE), used are especially the alkali metal salts thereof, preferably the sodium salts thereof, further preferably selected from the group consisting of
   poly(methacrylic acid-co-methacrylic acid-polyethylene glycol monomethyl ether ester),
   poly(maleic acid-co-methacrylic acid-polyethylene glycol monomethyl ether ester),
   poly(methacrylic acid-co-methacrylic acid-polyethylene glycol monomethyl ether amide),
   poly(maleic acid-co-methacrylic acid-polyethylene glycol methyl ether ester),
   poly(maleic acid-co-methacrylic acid-polyethylene glycol monomethyl ether amide),
   poly(maleic acid-co-methacrylic acid-polyethylene glycol methylamide),
   poly(maleic acid-co-polyethylene glycol monoallyl ether-co-polyethylene glycol bismaleamide acid),
   poly(methacrylic acid-co-polyethylene glycol methyl vinyl ether),
   poly(maleic acid-co-polyethylene glycol methyl vinyl ether),
   poly(methacrylic acid-co-polyethylene glycol methyl allyl ether),
   poly(methacrylic acid-co-polyethylene glycol methyl methallyl ether),
   poly(maleic acid-co-polyethylene glycol methyl allyl ether),
   poly(maleic acid-co-polyethylene glycol methyl methallyl ether),
   poly(maleic acid-co-N,N-diallyl-N-methyl-N-polyethylene glycol monomethyl ether) and
   poly(methacrylic acid-co-N,N-diallyl-N-methyl-N-polyethylene glycol),
   wherein the polyethylene glycol (or polyethylene glycol methyl ether) radical in the above-listed anionic polymers is —[CH₂—CH₂—O]ₐ—H or —[CH₂—CH₂—O]ₐ—CH₃; wherein a denotes the degree of ethoxylation (number of monomeric repeat ethylene oxide units), wherein a is an integer in the range from 1 to 100.
22. The process for preparing a polyion complex according to any of embodiments 15 to 21, wherein the polymers or copolymers further comprise one or more further polymers or copolymers selected from the group consisting of
   m) poly(2-acrylamido-2-methylpropanesulfonate);
   n) poly(p-styrenesulfonic acid);
   o) poly(p-styrenesulfonic acid-co-maleic acid);
   p) poly(dimethyldiallylammonium-co-acryloylhydroxamatobetaine) partially anionic;
   q) poly(meth)acrylate;
   r) poly(meth)acrylic acid crosslinked with pentaerythritol triallyl ether [≤0.5 mol %];
   s) polymeric natural substances, modified to anionic polymers with alkali metal (especially sodium) chloroacetate or (hydrogen)sulfite, preferably selected from the group consisting of carboxymethylcellulose, carboxymethylstarch, lignosulfonate and mixtures of two or more of these modified polymeric natural substances; and
   t) anionic inorganic polymers, preferably selected from the group consisting of hexametaphosphate (PO₃⁻)₆, silicate Si₃O₇²⁻, and mixtures of two or more of these inorganic polymers;
      wherein the negative charge of the in each case is compensated by one or more singly charged cation(s), preferably one cation selected from the group consisting of sodium cation, potassium cation, ammonium cation and mixtures of two or more of these cations.
23. The process for preparing a polyion complex according to embodiment 22, wherein the further polymers or copolymer are selected from the group consisting of
   m.1) poly(2-acrylamido-2-methylpropanesulfonate) sodium salt;
   n.1) poly(p-styrenesulfonic acid) ammonium salt;
   o.1) poly(p-styrenesulfonic acid-co-maleic acid) sodium salt;
   p.1) poly(dimethyldiallylammonium-co-acryloylhydroxamatobetaine) partial ammonium salt,
   q.1) sodium or potassium salts of poly(meth)acrylate;
   r.1) poly(meth)acrylic acid crosslinked with pentaerythritol triallyl ether [≤0.5 mol %] and partially neutralized with sodium hydroxide or potassium hydroxide solution to give sodium or potassium salts;
   s.1) polymeric natural substances, modified to anionic polymers with sodium chloroacetate, selected from the group consisting of carboxymethylcellulose sodium salt, carboxymethylstarch sodium salt, lignosulfonate sodium salt and mixtures of two or more of these polymeric natural substances; and
   t.1) anionic inorganic polymers, selected from the group consisting of
      sodium hexametaphosphate (NaPO₃)₆,
      sodium silicate Na₂Si₃O₇,
      potassium silicate K₂O.nSiO₂,
      lithium polysilicate Li₂O.5SiO₂ and mixtures of two or more of these inorganic polymers.
24. The process for preparing a polyion complex according to any of embodiments 15 to 23, wherein the polyion complex further comprises one or more nonionic water-soluble monomers, preferably selected from the group consisting of N-vinyllactam, carboxamide and carbonic acid derivative, further preferably from the group consisting of N-vinylpyrrolidone, N-vinylpiperidone, N-vinylcaprolactam and N-vinylformamide, N-vinylacetamide, N-methyl-N-vinylacetamide, acrylamide, methacrylamide, N,N-dimethylacrylamide, N,N-dimethylmethacrylamide, N-methylolmethacrylamide, N-hydroxyethylmethacrylamide, N-hydroxypropylmethacrylamide, vinyl acetate, acrylonitrile and C₁ to C₆-alkyl ethylene glycol (meth)acrylate having 1 to 80 monomeric repeat ethylene oxide units in the ethylene glycol radical.
25. The process for preparing a polyion complex according to any of embodiments 15 to 24, wherein the polyion complex has the general formula (I)

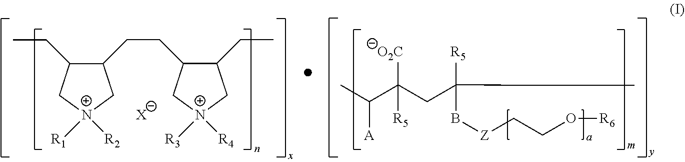

wherein:
R₁, R₂ are independently selected from the group consisting of hydrogen atom, C₁ to C₁₈-alkyl radical, polyethylene glycol radical —[CH₂—CH₂—O]ₐ—H, and polyethylene glycol methyl ether radical —[CH₂—CH₂—O]ₐ—CH₃, wherein a is an integer in the range from 1 to 100;
X⁻ is a halide anion or methosulfate anion, preferably a chloride anion;
R₃, R₄:
   are either independently selected from the group consisting of hydrogen atom, C₁ to C₁₈-alkyl radical, polyethylene glycol radical —[CH₂—CH₂—O]ₐ—H, and polyethylene glycol C₁ to C₁₈-alkyl ether radical, preferably —[CH₂—CH₂—O]ₐ—CH₃, wherein a is an integer in the range from 1 to 100;
   or
   represent a radical of the general formula (II)

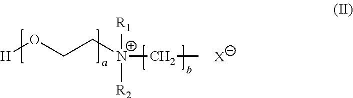

wherein X⁻, R₁, R₂ and a have the definitions given above for the general formula (II), b is 2 or 3;
   or
   represent a radical of the general formula (III)

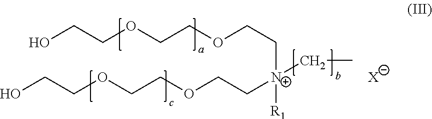

in which X⁻, R₁, a and b have the definitions given above for the general formula (II) or (III) and c is an integer in the range from
   1 to 100;
R₅ is a hydrogen atom or a methyl group;
R₆ is a hydrogen atom or a C₁ to C₁₈-alkyl radical, preferably a methyl group;
A is a hydrogen atom, a carboxylate anion —CO₂⁻ or a carboxylate sodium —CO₂Na,
B is a methylene group —CH₂— or a carbonyl group —CO—, or the bridge group is absent,
Z is an oxygen atom or a nitrogen radical NR₆ with the definition already given for R₆;
n, m are independently either the same or different and denote the degree of polymerization that represents the number of monomeric repeat units in the polymer,
x, y are numbers from the range from 1 to 100, where, preferably, x≥y or x≤y.
26. The process for preparing a polyion complex according to any of embodiments 15 to 25, wherein the polyion complex is in aqueous solution, wherein preferably ≥90% by weight of the aqueous solution of the polyion complex consists of polyion complex and water;
27. The process for preparing a polyion complex according to any of embodiments 15 to 26, wherein the aqueous solution of the polyion complex comprises more than 10% by weight, preferably more than 20% by weight, further preferably more than 50% by weight, of water, based on the total weight of the respective aqueous solution.
28. The process for preparing a polyion complex according to any of embodiments 15 to 27, wherein the aqueous solution of the polyion complex has a pH in the range from 6 to 9.
29. An aqueous solution of a polyion complex obtained or obtainable by the process according to any of embodiments 15 to 28.
30. The aqueous solution of a polyion complex comprising x mol of polycations and y mol of polyanions, wherein x and y are each integers from the range from 1 to 100 and x≤y or x≥y.
31. An aqueous solution of a polyion complex according to embodiment 30, wherein the polycations are cationic polymers or copolymers, preferably cationic polymers or copolymers having at least one quaternary ammonium cation and further preferably selected from the group consisting of
   a) poly-N,N,N-tri-C₁-C₅-alkylammonioalkyl acrylate, wherein the poly-N,N,N-tri-C₁-C₅-alkylammonioalkyl acrylate is preferably selected from the group consisting of poly-N,N,N-[3-(trimethylammonio)ethyl] acrylate, poly-N,N,N-[3-(trimethylammonio)propyl] acrylate, poly-N,N,N-[3-(trimethylammonio)butyl] acrylate, poly-N,N,N-[3-(methyldiethylammonio)propyl] acrylate and mixtures of two or more of these poly-N,N,N-tri-C₁-C₅-alkylammonioalkyl acrylates;
   b) poly-N,N,N-tri-C₁-C₅-alkylammonioalkyl methacrylate, wherein the poly-N,N,N-tri-C₁-C₅-alkylammonioalkyl methacrylate is preferably selected from the group consisting of poly-N,N,N-[3-(trimethylammonio)ethyl] methacrylate, poly-N,N,N-[3(trimethylammonio)propyl] methacrylate, poly-N,N,N-[3-(trimethylammonio)butyl] methacrylate, poly-N,N,N[3-(methyldiethylammonio)propyl] methacrylate and mixtures of two or more of these poly-N,N,N-tri-C₁-C₅-alkylammonioalkyl methacrylates;
   c) poly-N,N,N-tri-C1-C5-alkylammonioalkylacrylamide, wherein the poly-N,N,N-tri-C₁-C₅-alkylammonioalkylacrylamide is preferably selected from the group consisting of poly-N,N,N[3-(trimethylammonio)ethyl]acrylamide, poly-N,N,N-[3-(trimethylammonio)propyl]acrylamide, poly-N,N,N-[3-(trimethylammonio)butyl]acrylamide, poly-N,N,N-[3-(methyldiethylammonio)propyl]acrylamide and mixtures of two or more of these poly-N,N,N-tri-C₁-C₅-alkylammonioalkylacrylamides;
   d) poly-N,N,N-tri-C₁-C₅-alkylammonioalkylmethacrylamide, wherein the poly-N,N,N-tri-C₁-C₅-alkylammonioalkylmethacrylamide is preferably selected from the group consisting of poly-N,N,N-[3-(trimethylammonio)ethyl]methacrylamide, poly-N,N,N-[3-(trimethylammonio)propyl]methacrylamide, poly-N,N,N-[3-(trimethylammonio)butyl]methacrylamide, poly-N,N,N-[3-(methyldiethylammonio)propyl]methacrylamide and mixtures of two or more of these poly-N,N,N-tri-C₁-C₅-alkylammonioalkylmethacrylamides;
   e) poly-N-3-methyl-1-vinylimidazolium;
   f) quaternized poly [bis(2-chloroethyl) ether-alt-1,3-bis-(3-dimethylamino-propyl)urea];
   g) poly(dimethylamine-co-epichlorohydrin-co-ethylenediamine);
   h) polydimethyldiallylammonium; and
   i) poly(dimethyldiallylammonium-co-methyldiallylamine hydrochloride);
      wherein the positive charge of the nitrogen atom of the quaternary ammonium cation is compensated by a singly charged anion, preferably an anion selected from the group consisting of halide anions, especially chloride anion, methosulfate anion, ethosulfate anion and mixtures of two or more of these anions.
32. The aqueous solution of a polyion complex according to embodiment 31, wherein the polycations are cationic polymers or copolymers having at least one quaternary ammonium cation and selected from the group consisting of
   a.1) poly-N,N,N-tri-C₁-C₅-alkylammonioalkylacrylate chloride or methosulfate, preferably selected from the group consisting of
      poly-N,N,N-[3-(trimethylammonio)ethyl]acrylate chloride,
      poly-N,N,N-[3-(trimethylammonio)propyl]acrylate chloride,
      poly-N,N,N-[3-(trimethylammonio)butyl]acrylate chloride,
      poly-N,N,N-[3-(methyldiethylammonio)propyl]acrylate methosulfate, and mixtures of two or more of these poly-N,N,N-tri-C₁-C₅-alkylammonioalkylacrylate chlorides or methosulfates;
   b.1) poly-N,N,N-tri-C₁-C₅-alkylammonioalkylmethacrylate chloride or methosulfate, preferably selected from the group consisting of
      poly-N,N,N-[3-(trimethylammonio)ethyl]methacrylate chloride,
      poly-N,N,N-[3-(trimethylammonio)propyl]methacrylate chloride,
      poly-N,N,N-[3-(trimethylammonio)butyl]methacrylate chloride,
      poly-N,N,N-[3-(methyldiethylammonio)propyl]methacrylate methosulfate, and mixtures of two or more of these poly-N,N,N-tri-C1-C5-alkylammonioalkylmethacrylate chlorides or methosulfates;
   c.1) poly-N,N,N-tri-C₁-C₅-alkylammonioalkylacrylamide chloride or methosulfate, preferably selected from the group consisting of
      poly-N,N,N[3-(trimethylammonio)ethyl]acrylamide chloride,
      poly-N,N,N[3-(trimethylammonio)propyl]acrylamide chloride,
      poly-N,N,N[3-(trimethylammonio)butyl]acrylamide chloride,
      poly-N,N,N[3-(methyldiethylammonio)propyl]acrylamide chloride, and mixtures of two or more of these poly-N,N,N-tri-C₁-C₅-alkylammonioalkylacrylamide chlorides or methosulfates;
   d.1) poly-N,N,N-tri-C₁-C₅-alkylammonioalkylmethacrylamide chloride or methosulfate,
      preferably selected from the group consisting of
      poly-N,N,N-[3-(trimethylammonio)ethyl]methacrylamide chloride,
      poly-N,N,N-[3-(trimethylammonio)propyl]methacrylamide chloride,
      poly-N,N,N-[3-(trimethylammonio)butyl]methacrylamide chloride,
      poly-N,N,N-[3-(methyldiethylammonio)propyl]methacrylamide chloride, and mixtures of two or more of these poly-N,N,N-tri-C₁-C₅-alkylammonioalkylmethacrylamide chlorides or methosulfates;
   e.1) poly-N-3-methyl-1-vinylimidazolium chloride;
   f.1) poly-[bis(2-chloroethyl) ether-alt-1,3-bis-(3-dimethylaminopropyl)urea], quaternized;
   g.1) poly(dimethylamine-co-epichlorohydrin-co-ethylenediamine);
   h.1) polydimethyldiallylammonium chloride; and
   i.1) poly(dimethyldiallylammonium chloride-co-methyldiallylamine hydrochloride).
32. The aqueous solution of a polyion complex according to embodiment 30 or 31, wherein the polyanions are anionic polymers or copolymers present in the form of alkali metal salts, preferably selected from the group consisting of lithium salt, sodium salt and potassium salt, and/or ammonium salts, further preferably as sodium salts.
33. The aqueous solution of a polyion complex according to any of embodiments 30 to 32, wherein the anionic polymers or copolymers include at least one at least one polycarboxylate ether (PCE), wherein the at least one PCE is preferably selected from the group consisting of poly(methacrylic acid-co-methacrylic acid-polyethylene glycol monomethyl ether ester), poly(maleic acid-co-methacrylic acid-polyethylene glycol monomethyl ether ester), poly(methacrylic acid-co-methacrylic acid-polyethylene glycol monomethyl ether amide),
   poly(maleic acid-co-methacrylic acid-polyethylene glycol methyl ether ester),
   poly(maleic acid-co-methacrylic acid-polyethylene glycol monomethyl ether amide),
   poly(maleic acid-co-methacrylic acid-polyethylene glycol methylamide), poly(maleic acid-co-polyethylene glycol monoallyl ether-co-polyethylene glycol bismaleamide acid), poly(methacrylic acid-co-polyethylene glycol methyl vinyl ether), poly(maleic acid-co-polyethylene glycol methyl vinyl ether), poly(methacrylic acid-co-polyethylene glycol methyl allyl ether), poly(methacrylic acid-co-polyethylene glycol methyl methallyl ether), poly(maleic acid-co-polyethylene glycol methyl allyl ether),
   poly(maleic acid-co-polyethylene glycol methyl methallyl ether), poly(maleic acid-co-N,N-diallyl-N-methyl-N-polyethylene glycol monomethyl ether) and
   poly(methacrylic acid-co-N,N-diallyl-N-methyl-N-polyethylene glycol),
   wherein the polyethylene glycol (or polyethylene glycol methyl ether) radical in the above-listed anionic polymers is —[CH₂—CH₂—O]ₐ—H or —[CH₂—CH₂—O]ₐ—CH₃; wherein a denotes the degree of ethoxylation (number of monomeric repeat ethylene oxide units), wherein a is an integer in the range from 1 to 100; and wherein the negative charge is compensated in each case by one or more single charged cation(s), preferably one cation selected from the group consisting of sodium cation, potassium cation, ammonium cation and mixtures of two or more of these cations.
34. The aqueous solution of a polyion complex according to any of embodiments 30 to 33, wherein the polycarboxylate ethers (PCEs) used are especially the alkali metal salts thereof, preferably the sodium salts thereof, further preferably selected from the group consisting of
   poly(methacrylic acid-co-methacrylic acid-polyethylene glycol monomethyl ether ester),
   poly(maleic acid-co-methacrylic acid-polyethylene glycol monomethyl ether ester),
   poly(methacrylic acid-co-methacrylic acid-polyethylene glycol monomethyl ether amide),
   poly(maleic acid-co-methacrylic acid-polyethylene glycol monomethyl ether ester),
   poly(maleic acid-co-methacrylic acid-polyethylene glycol monomethyl ether amide),
   poly(maleic acid-co-methacrylic acid-polyethylene glycol methylamide),
   poly(maleic acid-co-polyethylene glycol monoallyl ether-co-polyethylene glycol bismaleamide acid),
   poly(methacrylic acid-co-polyethylene glycol methyl vinyl ether),
   poly(maleic acid-co-polyethylene glycol methyl vinyl ether),
   poly(methacrylic acid-co-polyethylene glycol methyl allyl ether),
   poly(methacrylic acid-co-polyethylene glycol methyl methallyl ether),
   poly(maleic acid-co-polyethylene glycol methyl allyl ether),
   poly(maleic acid-co-polyethylene glycol methyl methallyl ether),
   poly(maleic acid-co-N,N-diallyl-N-methyl-N-polyethylene glycol monomethyl ether) and
   poly(methacrylic acid-co-N,N-diallyl-N-methyl-N-polyethylene glycol),
   wherein the polyethylene glycol (or polyethylene glycol methyl ether) radical in the above-listed anionic polymers is —[CH₂—CH₂—O]ₐ—H or —[CH₂—CH₂—O]ₐ—CH₃; wherein a denotes the degree of ethoxylation (number of monomeric repeat ethylene oxide units), wherein a is an integer in the range from 1 to 100.
35. The aqueous solution of a polyion complex according to any of embodiments 30 to 34, wherein the polymers or copolymers further comprise one or more further polymers or copolymers selected from the group consisting of
   m) poly(2-acrylamido-2-methylpropanesulfonate);
   n) poly(p-styrenesulfonic acid);
   o) poly(p-styrenesulfonic acid-co-maleic acid);
   p) poly(dimethyldiallylammonium-co-acryloylhydroxamatobetaine) partially anionic;
   q) poly(meth)acrylate;
   r) poly(meth)acrylic acid crosslinked with pentaerythritol triallyl ether [≤0.5 mol %];
   s) polymeric natural substances, modified to anionic polymers with alkali metal (especially sodium) chloroacetate or (hydrogen)sulfite, preferably selected from the group consisting of carboxymethylcellulose, carboxymethylstarch, lignosulfonate and mixtures of two or more of these modified polymeric natural substances; and
   t) anionic inorganic polymers, preferably selected from the group consisting of hexametaphosphate (PO₃⁻)₆, silicate Si₃O₇²⁻, and mixtures of two or more of these inorganic polymers;
      wherein the negative charge of the in each case is compensated by one or more singly charged cation(s), preferably one cation selected from the group consisting of sodium cation, potassium cation, ammonium cation and mixtures of two or more of these cations.
36. The aqueous solution of a polyion complex according to embodiment 35, wherein the further polymers or copolymer are selected from the group consisting of
   m.1) poly(2-acrylamido-2-methylpropanesulfonate) sodium salt;
   n.1) poly(p-styrenesulfonic acid) ammonium salt;
   o.1) poly(p-styrenesulfonic acid-co-maleic acid) sodium salt;
   p.1) poly(dimethyldiallylammonium-co-acryloylhydroxamatobetaine) partial ammonium salt,
   q.1) sodium or potassium salts of poly(meth)acrylate;
   r.1) poly(meth)acrylic acid crosslinked with pentaerythritol triallyl ether [≤0.5 mol %] and partially neutralized with sodium hydroxide or potassium hydroxide solution to give sodium or potassium salts;
   s.1) polymeric natural substances, modified to anionic polymers with sodium chloroacetate, selected from the group consisting of carboxymethylcellulose sodium salt, carboxymethylstarch sodium salt, lignosulfonate sodium salt and mixtures of two or more of these polymeric natural substances; and
   t.1) anionic inorganic polymers, selected from the group consisting of
      sodium hexametaphosphate (NaPO₃)₆,
      sodium silicate Na₂Si₃O₇,
      potassium silicate K₂O.nSiO₂,
      lithium polysilicate Li₂O.5Si₂ and mixtures of two or more of these inorganic polymers.
37. The aqueous solution of a polyion complex according to any of embodiments 30 to 36, wherein the polyion complex further comprises one or more nonionic water-soluble monomers, preferably selected from the group consisting of N-vinyllactam, carboxamide and carbonic acid derivative, further preferably from the group consisting of N-vinylpyrrolidone, N-vinylpiperidone, N-vinylcaprolactam and N-vinylformamide, N-vinylacetamide, N-methyl-N-vinylacetamide, acrylamide, methacrylamide, N,N-dimethylacrylamide, N,N-dimethylmethacrylamide, N-methylolmethacrylamide, N-hydroxyethylmethacrylamide, N-hydroxypropylmethacrylamide, vinyl acetate, acrylonitrile and C₁ to C₆-alkyl ethylene glycol (meth)acrylate having 1 to 80 monomeric repeat ethylene oxide units in the ethylene glycol radical.
38. The aqueous solution of a polyion complex according to any of embodiments 30 to 37, wherein the polyion complex has the general formula (I)

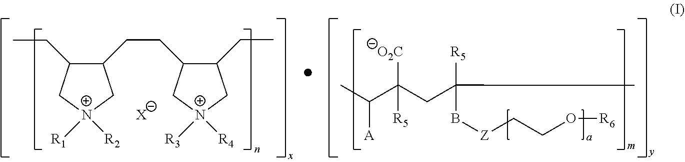

wherein:
R₁, R₂ are independently selected from the group consisting of hydrogen atom, C₁ to C₁₈-alkyl radical, polyethylene glycol radical —[CH₂—CH₂—O]ₐ—H, and polyethylene glycol methyl ether radical —[CH₂—CH₂—O]ₐ—CH₃, wherein a is an integer in the range from 1 to 100;
X⁻ is a halide anion or methosulfate anion, preferably a chloride anion;
R₃, R₄:
   are either independently selected from the group consisting of hydrogen atom, C₁ to C₁₈-alkyl radical, polyethylene glycol radical —[CH₂—CH₂—O]ₐ—H, and polyethylene glycol C₁ to C₁₈-alkyl ether radical, preferably —[CH₂—CH₂—O]ₐ—CH₃, wherein a is an integer in the range from 1 to 100;
   or
   represent a radical of the general formula (II)

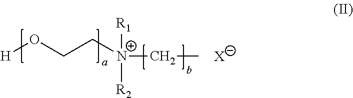

wherein X⁻, R₁, R₂ and a have the definitions given above for the general formula (II), b is 2 or 3;
   or
   represent a radical of the general formula (III)

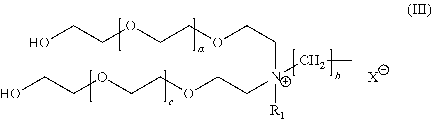

in which X⁻, R₁, a and b have the definitions given above for the general formula (II) or (III) and c is an integer in the range from
   1 to 100;
R₅ is a hydrogen atom or a methyl group;
R₆ is a hydrogen atom or a C₁ to C₁₈-alkyl radical, preferably a methyl group;
A is a hydrogen atom, a carboxylate anion —CO₂⁻ or a carboxylate sodium —CO₂Na,
B is a methylene group —CH₂— or a carbonyl group —CO—, or the bridge group is absent,
Z is an oxygen atom or a nitrogen radical NR₆ with the definition already given for R₆;
n, m are independently either the same or different and denote the degree of polymerization that represents the number of monomeric repeat units in the polymer,
x, y are numbers from the range from 1 to 100, where, preferably, x≥y or x≤y.
39. The aqueous solution of a polyion complex according to any of embodiments 30 to 38, wherein the polyion complex is in aqueous solution, wherein preferably ≥90% by weight of the aqueous solution of the polyion complex consists of polyion complex and water;
40. The aqueous solution of a polyion complex according to any of embodiments 30 to 39, wherein the aqueous solution of the polyion complex comprises more than 10% by weight, preferably more than 20% by weight, further preferably more than 50% by weight, of water, based on the total weight of the respective aqueous solution.
41. The aqueous solution of a polyion complex according to any of embodiments 30 to 40, wherein the aqueous solution of the polyion complex comprises 0.01% to 5.0% by weight, preferably 0.1% to 3.0% by weight, of polyion complex, based on the total weight of the respective aqueous solution.
42. The aqueous solution of a polyion complex according to any of embodiments 30 to 41, wherein the aqueous solution of the polyion complex has a pH in the range from 6 to 9.
43. The use of a polyion complex, especially an aqueous solution of a polyion complex, wherein the polyion complex comprises x mol of polycations and y mol of polyanions, wherein x and y are each integers from the range from 1 to 100 and x≤y or x≥y, according to any of embodiments 1 to 14 or 30 to 42 for surface modification, especially surface hydrophilization, of polymer fibers and/or carbon fibers.
45. The use according to embodiment 43 or 44, wherein the polymer fibers and/or carbon fibers have a fiber length of 2 to 16 mm, preferably 6 to 8 mm, and a fiber diameter of 5 to 120 μm, preferably of 7 to 15.4 μm.
46. A process for surface modification, especially surface hydrophilization, of polymer fibers and/or carbon fibers, comprising:
   a) providing polymer fibers and/or carbon fibers;
   b) providing an aqueous solution of a polyion complex, wherein the polyion complex comprises x mol of polycations and y mol of polyanions, wherein x and y are each integers from the range from 1 to 100 and x≤y or x≥y;
   c) mixing the polymer fibers and/or carbon fibers provided in (a) and the aqueous solution of the polyion complex from (b) to obtain an aqueous mixture comprising surface-modified polymer fibers and/or carbon fibers;
   d) separating the surface-modified polymer fibers and/or carbon fibers from the aqueous mixture in (c) (filtering, sieving, decanting) to obtain wet surface-modified polymer fibers and/or carbon fibers having a water content of 0.1% to 50% by weight, preferably between 5% and 40% by weight (wet fibers);
   e) compacting, especially mechanically compacting on the industrial scale, for example with the aid of a roll mill, or on the laboratory scale, for example with the aid of a plunger, the wet fibers obtained in (d) to obtain compacted wet fibers, for example in the form of a compact, i.e. compacted, felt layer of layer height 1 to 10 mm;
   f) optionally drying the surface-modified polymer fibers and/or carbon fibers separated in (d) or the wet fibers compacted in (e), preferably at a temperature in the range from 5 to 70° C., preferably 15 to 30° C.
47. The process for surface modification, especially surface hydrophilization, of polymer fibers and/or carbon fibers, according to embodiment 46, wherein at least one interface-active compound is also added to aqueous solution of a polyion complex from (a), preferably at least one interface-active compound selected from the group of the interface-active compounds based on modified castor oil, further preferably selected from the group of the ricinoleic acid polyethylene glycol esters, further preferably selected from the group of the ricinoleic acid polyethylene glycol esters having 10 to 50 repeat ethylene oxide units.
48. Surface-modified, especially hydrophilized, polymer fibers and/or carbon fibers, obtained or obtainable by the process according to embodiment 46 or 47, preferably obtained or obtainable in step (d) (wet fibers) or (e) (compacted wet fibers), further preferably obtained or obtainable in step (e) of embodiment 46 (compacted wet fibers).
49. Surface-modified, especially hydrophilized, polymer fibers and/or carbon fibers having a coating based on a polyion complex on at least part of the polymer fiber or carbon fiber surface, preferably over the entire polymer fiber or carbon fiber surface, wherein the polyion complex comprises x mol of polycations and y mol of polyanions, wherein x and y are each integers from the range from 1 to 100 and x≤y or x≥y; preferably based on a polyion complex according to any of embodiments 1 to 14.
50. The use of surface-modified, especially hydrophilized, polymer fibers and/or carbon fibers according to embodiment 49 or of surface-modified, especially hydrophilized, polymer fibers and/or carbon fibers obtained or obtainable by the process according to embodiment 46 or 47 for production of fiber-modified building materials, preferably fiber-modified gypsum, concrete or mortar systems.
51. A fiber-modified building material, especially fiber-modified gypsum, concrete or mortar system, comprising surface-modified, especially hydrophilized, polymer fibers and/or carbon fibers according to embodiment 49 or surface-modified, especially hydrophilized, polymer fibers and/or carbon fibers obtained or obtainable by the process according to embodiment 46 or 47.

There follows a detailed elucidation of the invention by examples, without restriction of the invention thereto.

### EXAMPLES

All figures of amount (g in mmol) in the examples that follow relate to salts of polyions or their parent monomeric repeat units.

1. Chemicals

| Name | Details |
|---|---|
| Potassium carbonate | Neutralizing agent |
| Sodium chloride | Extra electrolyte additive |
| Sodium lauryl ether sulfate | 70% by weight aqueous surfactant solution |

Polycation:

| | |
|---|---|
| Polydimethyldiallylammonium | 20% by weight aqueous polymer solution; |
| chloride solution | molar mass range: 70 000 to 75 000 g/mol |

Polyanion:

| | |
|---|---|
| Polyacrylic acid (½ sodium | Powder; ½ sodium salt with pentaerythritol |
| salt) | triallyl ether-branched polyacrylic acid |
| Sodium hexametaphosphate | (NaPO₃)₆ |
| Poly(2-acrylamido-2- | 15% by weight aqueous anionic polymer solution |
| methylpropanesulfonic acid) | |
| Poly(methacrylic acid-co- | 25.5% by weight aqueous anionic polymer |
| methacrylic acid-polyethylene | solution |
| glycol monomethyl ether ester) | |
| sodium salt | |
| N-n-Hexadecyl/n-octadecyl- | 35.0% by weight aqueous surfactant solution |
| N,N-bis(pentaethylene glycol)- | |
| 2-sulfinato-3- | |
| sulfopropylammoniobetaine | |
| solution | |
| n-Hexadecyl/n- | 70% by weight aqueous surfactant solution |
| octadecylbis(pentaethylene | |
| glycol)amine oxide solution | |
| Poly(dimethyldiallylammonium- | 10% by weight aqueous anionic betaine |
| co-acryloylhydroxamatobetaine- | copolymer solution |
| co-acryloylhydroxamate) | |
| ammonium salt solution | |

Interface-active compound:

| | |
|---|---|
| Ricinoleic acid polyethylene | 95% strength by weight surfactant with |
| glycol ester | 5% by weight of water |

Fibers:

| | |
|---|---|
| Polyacrylonitrile fibers | High-modules fibers of the following types: |
| (PAC) | PAC 251/2.1 dtex/2 F (fiber length 2 mm), |
| | PAC 251/2.1 dtex/4 T (fiber length 4 mm) and |
| | PAC 251/2.1 dtex/6 T (fiber length 6 mm), |
| | PAC 251/2.1 dtex |
| | (fiber length 8 mm) and PAC 251/2.1 dtex |
| | (fiber length 12 mm) |
| Polypropylene fibers | PB EUROFIBER MF 1217 (100% Polypropylene |
| (PP) | Multifil Fiber)/1.7 dtex/fiber diameter |
| | 15.4 μm/fiber length 12 mm, moisture |
| | content 0.4% |
| Carbon fibers | Short carbon fibers of the SFC 6 EPB type |
| | with diameter 7 μm for a single filament, |
| | fiber length 6 mm and size content 3% |

Characteristics of the Fibers

| | PAN fibers | Carbon fibers | PP fibers |
|---|---|---|---|
| Tensile strength [N/mm²] | 330-530 | 4-3 | 320-700 |
| Modulus of elasticity | 15-20 | 350-450 | 4-18 |
| [kN/m²] | | | |
| Apparent density [g/cm³] | 1.18 | 1.8 | 1.0 |
| Diameter [μm] | 18-104 | 5-10 | 18-22 |
| Surface area [m²/kg] | 225 | not stated | 125 |
| Elongation at break % | 6-10 | 0.4-1.1 | 8-20 |

2. Experiments

2.1 Preparation of the Polyion Complex Solutions

### Example 1

In a 200 ml beaker equipped with a dumbbell-shaped magnetic stirrer, 17.02 g (8.25 mmol) of 25.5% by weight poly(methacrylic acid-co-methacrylic acid-polyethylene glycol monomethyl ether ester) sodium salt solution (polycarboxylate ether; abbreviated to PCE) and 0.05 g of a 70% by weight sodium lauryl ether sulfate solution were dissolved in 82.9 g of water to give a brown homogeneous solution, and initially charged. 100 g (123.7 mmol) of a 20% by weight polydimethyldiallylammonium chloride solution was then added to this solution while stirring over the course of one minute, and hence it was converted to the polyion complex of substoichiometric composition.

This gave a brown, but transparent, viscous solution of pH ˜8. In the polyion complex solution, the molar ratio of the polycations to the polyanions was 15 to 1.

The concentration of the polyion complex in the solution was 11.93% by weight.

### Example 2

By the procedure as described in example 1, a solution was prepared by stirring from 48.9 g of water, 51.02 g (24.74 mmol) of 25.5% by weight poly(methacrylic acid-co-methacrylic acid-polyethylene glycol methyl ether ester) sodium salt solution, 0.05 g of 70% by weight n-hexadecyl/n-octadecylbis(pentaethylene glycol)amine oxide solution and 100 g (123.7 mmol) of 20% by weight polydimethyldiallylammonium chloride solution.

The polyion complex was obtained as a brown, but transparent, viscous solution of pH ˜8, in which the molar ratio of the polycations to the polyanions was 5 to 1.

The concentration of the polyion complex in the solution was 15.8% by weight.

### Example 3

By the procedure as described in example 1, a light brown homogeneous solution was prepared by stirring in a beaker from 86.6 g of water, 0.05 g of a 70% by weight n-hexadecyl/n-octadecylbis(pentaethylene glycol)amine oxide solution, 0.63 g (6.19 mmol) of sodium hexametaphosphate, (NaPO₃)₆, and 12.77 g (6.19 mmol) of 25.5% by weight poly(methacrylic acid-co-methacrylic acid-polyethylene glycol monomethyl ether ester) sodium salt solution (PCE), and initially charged.

To this solution was now added 100.0 g (123.7 mmol) of 20% by weight polydimethyldiallylammonium chloride solution while stirring over the course of about one minute, and hence it was converted to the polyion complex. This gave a light brown, but clearly transparent, viscous solution of pH ˜8.

In the polyion complex solution of substoichiometric composition, the molar ratio of the polycations to the sum total of the polyanions [sodium hexametaphosphate and polycarboxylate ether] was 10 to 1.

The concentration of the polyion complex in the solution was 11.58% by weight.

### Example 4

In a 200 ml beaker equipped with a dumbbell-shaped magnetic stirrer, a light brown homogeneous solution was prepared from 88.7 g of water, 30 mg of potassium carbonate, 1.0 g of sodium chloride, 0.05 g of a 70% by weight sodium lauryl ether sulfate solution and 10.22 g (4.95 mmol) of 25.5% by weight poly(methacrylic acid-co-methacrylic acid-polyethylene glycol monomethyl ether ester) sodium salt solution (PCE) by stirring, and initially charged. 0.1 g (1.24 mmol) of pulverulent polyacrylic acid ½ sodium salt was added in portions with the aid of a weighing boat and with simultaneous stirring. Over the course of 30 minutes, the polyanion dissolved to give a light brown, slightly cloudy, but transparent solution of pH ˜8. Now a second beaker was initially charged with 100.0 g (123.7 mmol) of 20% by weight polydimethyldiallylammonium chloride solution as polycationic component. Over the course of 1 to 2 minutes, the polycarboxylate ether and polyacrylate ½ sodium, ½ potassium salt solution (this mixture of the polyacrylate salts is formed from the polyacrylic acid ½ sodium salt by neutralization with potassium carbonate) were then allowed to flow gradually into this solution while stirring with a dumbbell-shaped magnetic stirrer, and stirring of the mixture was continued briefly until a homogeneous phase had formed. This give a light brown, cloudy and viscous polyion complex solution of pH ˜8. In the polyion complex solution of substoichiometric composition, the molar ratio of the polycations to the sum total of the polyanions [polycarboxylate ether and polyacrylate] was 20 to 1.

The concentration of the polyion complex in the solution was 11.26% by weight.

### Example 5

In a 200 ml beaker, equipped with a dumbbell-shaped magnetic stirrer, 6.56 g (6.19 mmol) of 10% by weight poly(dimethyldiallylammonium-co-acryloylhydroxamatobetaine-co-acryloylhydroxamate) ammonium salt solution [anionic betaine copolymer*], 50 g (61.85 mmol) of 20% by weight polydimethyldiallylammonium chloride solution, 0.05 g of 70% by weight sodium lauryl ether sulfate solution and 12.77 g (6.19 mmol) of 25.5% by weight poly(methacrylic acid-co-methacrylic acid-polyethylene glycol-monomethyl ether ester) sodium salt solution (polycarboxylate ether) were dissolved while stirring in 130.6 g of water to give a clear light brown viscous solution, and these were converted to the polyion complex solution of pH ˜8. *Poly(dimethyldiallylammonium 45 mol %-co-acryloylhydroxamatobetaine 45 mol %-co-acryloylhydroxamate 10 mol % ammonium salt) [see formula (IV)] is obtained by reaction, in aqueous alkaline medium, of poly(acrylamide 55 mol %-co-dimethyldiallylammonium chloride 45 mol %) with hydroxylamine at pH ˜10 and at temperatures around 70° C. The general number n in the formula (IV) denotes the degree of polymerization in the copolymer. The numbers in the structural formula, expressed in mol %, indicate the percentage composition of the different monomeric repeat units in the copolymer.

In the polyion complex solution, the molar ratio of the polycations to the sum total of the polyanions [anionic betaine copolymer* and polycarboxylate ether] was 5 to 1.

The concentration of the polyion complex in the solution was 5.95% by weight.

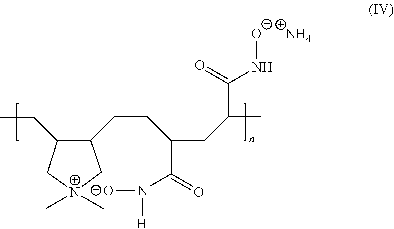

45 mol % 45 mol % 10 mol %

### Example 6

In a 200 ml beaker, equipped with a dumbbell-shaped magnetic stirrer, as well as 0.05 g of a 70% by weight n-hexadecyl/n-octadecylbis(pentaethylene glycol)amine oxide solution and 0.04 g of potassium carbonate, 0.85 g (0.62 mmol) of 15% by weight aqueous poly(2-acrylamido-2-methylpropanesulfonic acid) solution, 0.57 g (5.56 mmol) of sodium hexametaphosphate, (NaPO₃)₆, and 12.77 g (6.19 mmol) of 25.5% by weight poly(methacrylic acid-co-methacrylic acid-polyethylene glycol monomethyl ether ester) sodium salt solution (polycarboxylate ether) as polyanionic components were dissolved in 85.7 g of water to give a light brown homogeneous solution. Thereafter, the polyion solution was converted to the polyion complex by adding 100.0 g (123.7 mmol) of 20% by weight polydimethyldiallylammonium chloride solution as polycationic component while stirring.

This gave a light brown, opaquely cloudy, viscous solution of pH ˜8.

In the polyion complex solution of substoichiometric composition, the molar ratio of the polycations to the sum total of the polyanions [poly(2-acrylamido-2-methylpropanesulfonate), sodium hexametaphosphate and polycarboxylate ether] was 10 to 1.

The concentration of the polyion complex in the solution was 12.0% by weight.

### Example 7

By the procedure as described in example 1, a solution was prepared by stirring from 14.8 g of water, 85.1 g (41.23 mmol) of 25.5% by weight poly(methacrylic acid-co-methacrylic acid-polyethylene glycol monomethyl ether ester) sodium salt solution, 0.05 g of 70% by weight n-hexadecyl/n-octadecylbis(pentaethylene glycol)amine oxide solution and 100.0 g (123.7 mmol) of 20% by weight polydimethyldiallylammonium chloride solution. The polyion complex was obtained as a brown viscous solution of pH ˜8, in which the molar ratio of the polycations to the polyanions was 3 to 1.

The concentration of the polyion complex in the solution was 19.65% by weight.

### Example 8

By the procedure as described in example 1, a solution was prepared by stirring from 86.1 g of water, 63.83 g (30.93 mmol) of 25.5% by weight poly(methacrylic acid-co-methacrylic acid-polyethylene glycol monomethyl ether ester) sodium salt solution and 0.1 g of 35.0% by weight N-n-hexadecyl/n-octadecyl-N,N-bis(pentaethylene glycol)-2-sulfinato-3-sulfopropylammoniobetaine solution, and initially charged. To this solution was now added 50.0 g (61.85 mmol) of 20% by weight polydimethyldiallylammonium chloride solution while stirring, and hence it was converted to the polyion complex.

A brown viscous solution of pH ˜8 was obtained, in which the molar ratio of the polycations to the polyanions was 2 to 1.

The concentration of the polyion complex in the solution was 12.23% by weight.

### Example 9

By the procedure as described in example 1, a solution was prepared by stirring from 35.0 g of water, 114.9 g (55.67 mmol) of 25.5% by weight poly(methacrylic acid-co-methacrylic acid-polyethylene glycol monomethyl ether ester) sodium salt solution and 0.1 g of 35.0% by weight N-n-hexadecyl/n-octadecyl-N,N-bis(pentaethylene glycol)-2-sulfinato-3-sulfopropylammoniobetaine solution.

Thereafter, 50.0 g (61.85 mmol) of 20% by weight polydimethyldiallylammonium chloride solution was added to that solution while stirring with aid of a magnetic stirrer, since the formation of the polyion complex was associated with a distinct increase in viscosity of the combined solutions. Over the course of a few minutes, a homogeneous, brown and viscous solution of pH ˜8 was obtained, in which the molar ratio of the polycations to the polyanions was 10 to 9.

The concentration of the polyion complex in the solution was 18.02% by weight.

### Example 10

By the procedure as described in example 9, a solution was prepared by stirring from 22.2 g of water, 127.7 g (61.85 mmol) of 25.5% by weight poly(methacrylic acid-co-methacrylic acid-polyethylene glycol monomethyl ether ester) sodium salt solution, 0.1 g of 35.0% by weight N-n-hexadecyl/n-octadecyl-N,N-bis(pentaethylene glycol)-2-sulfinato-3-sulfopropylammoniobetaine solution and 50.0 g (61.85 mmol) of 20% by weight polydimethyldiallylammonium chloride solution.

A homogeneous, brown and viscous solution of pH ˜8 was obtained, in which the molar ratio of the polycations to the polyanions was 1 to 1.

The concentration of the polyion complex in the solution was 19.47% by weight.

### Example 11

By the procedure as described in example 9, a solution was prepared by stirring from 51.8 g of water, 123.8 g (60.0 mmol) of 25.5% by weight poly(methacrylic acid-co-methacrylic acid-polyethylene glycol monomethyl ether ester) sodium salt solution, 0.1 g of 35.0% by weight N-n-hexadecyl/n-octadecyl-N,N-bis(pentaethylene glycol)-2-sulfinato-3-sulfopropylammoniobetaine solution and 24.3 g (30.0 mmol) of 20% by weight polydimethyldiallylammonium chloride solution. A homogeneous, brown and viscous solution of pH ˜7 was obtained, in which the molar ratio of the polycations to the polyanions was 1 to 2.

The concentration of the polyion complex in the solution was 17.34% by weight.

### Example 12

By the procedure as described in example 8, a solution was prepared by stirring from 59.9 g of water, 123.8 g (60.0 mmol) of 25.5% by weight poly(methacrylic acid-co-methacrylic acid-polyethylene glycol monomethyl ether ester) sodium salt solution, 0.1 g of 35.0% by weight N-n-hexadecyl/n-octadecyl-N,N-bis(pentaethylene glycol)-2-sulfinato-3-sulfopropylammoniobetaine solution and 16.17 g (20.0 mmol) of 20% by weight polydimethyldiallylammonium chloride solution. A homogeneous, brown and viscous solution of pH ˜7 was obtained, in which the molar ratio of the polycations to the polyanions was 1 to 3.

The concentration of the polyion complex in the solution was 16.82% by weight.

2.2 Use of Polyion Complex Formulations According to Examples 1 to 12 For Fiber Individualization

For use of the aqueous polyion complex formulations of examples 1 to 12, complexes of x moles of polycations and y moles of polyanions, wherein x≥y or x≤y, these were subjected to comparative testing for individualization of polymer fibers, in order to demonstrate the improved properties of the treatment agent and its functionality.

The comparative testing was effected with commercial polyacrylonitrile (PAC) high-module fibers of the following types: PAC 251/2.1 dtex/2F (fiber length 2.1 mm), PAC 251/2.1 dtex/4T (fiber length 4 mm) and PAC 251/2.1 dtex/6T (fiber length 6 mm), PAC 251/2.1 dtex (fiber length 8 mm) and PAC 251/2.1 dtex (fiber length 12 mm).

The polypropylene (PP) fibers used for testing were of the following type: PB EUROFIBER MF 1217 (100% Polypropylene Multifil Fiber)/1.7 dtex/fiber diameter 15.4 μm/fiber length 12 mm, moisture content 0.4%.

### Example 13

An amount of 10 g of PAC or PP polymer fibers of the types named at the beginning under 2.2. was weighed out.

The polyion complex formulations of examples 1 to 12 were used to produce 0.1%, 0.2%, 0.25%, 0.5% and 1.0% by weight aqueous solutions.

10 g of polymer fibers of the respective fiber lengths was initially charged in a beaker, 200 g in each case of a 0.1%, 0.2%, 0.25%, 0.5% or 1.0% by weight aqueous polyion complex formulation was added, and the mixture was mixed for one minute, and then left to stand for about 10 minutes.

The finished polymer fibers, with the aid of a frit, were freed of the excess solution until dripping wet, and then dried to constant weight under air at room temperature or in a drying cabinet at ˜50° C.

The polymer fibers modified with polyion complexes, or their surfaces, were stirred in water to verify their ability to individualize fibers—in commercial fiber products, the fibers are found in the form of “matted tufts, hedgehogs or clusters” that can be individualized in use only with difficulty, if at all.

In a beaker, 0.2 g in each case of commercial untreated fibers or fibers modified by way of comparison that had been treated beforehand with the inventive polyion complex compositions of examples 1 to 12 was added to 200 g of water.

The polymer fibers were stirred for 2 minutes at room temperature with a magnetic stirrer bar and at a stirrer speed of 500 revolutions/minute in order to ascertain the degree of fiber individualization.

The results of this comparative testing are summarized in table 1:

TABLE 1
Determination of the individualization of dried fibers
that had been treated beforehand with polyion complex
solutions, compared to untreated fibers.

| Fiber | Polyion | Fiber | |
|---|---|---|---|
| finish | complex | type | |
| according | Conc. in % | Length | Degree of fiber |
| to example | by weight | in mm | individualization |
| — | — | PAC/2 | only partial |
| — | — | PAC/4 | partial/“matted hedgehogs” |
| — | — | PAC/6 | “matted hedgehogs” only |
| — | — | PP/12 | “matted hedgehogs” only |
| 1 | 0.5 | PAC/2 | complete |
| 1 | 1.0 | PAC/4 | complete |
| 1 | 0.5 | PAC/4 | complete |
| 2 | 0.25 | PAC/4 | complete |
| 2 | 0.5 | PAC/4 | complete |
| 2 | 0.5 | PAC/6 | complete |
| 2 | 0.5 | PP/12 | complete |
| 3 | 0.5 | PAC/4 | complete |
| 3 | 1.0 | PAC/6 | complete |
| 3 | 1.0 | PP/12 | complete |
| 4 | 0.5 | PAC/6 | complete |
| 5 | 1.0 | PAC/4 | complete |
| 6 | 0.5 | PAC/4 | complete |

It was clearly apparent that the polymer fibers treated with polyion complex solutions beforehand showed much better fiber individualization compared to untreated fibers.

### Example 14

In this example, polymer fibers were treated with aqueous polyion complex solutions, which gave wet fibers having different moisture contents, in order to test the ability to individualize fibers thereon.

10 g in each case of PAC or PP polymer fibers of the types named at the beginning under 2.2 was provided.

From the polyion complex formulations of examples 7 to 12, a respective amount of 0.1 g, 0.15 g, 0.2 g, 0.25 g or 0.3 g of the aqueous solution was taken and diluted with the appropriate amount of water. After addition of this solution to the respective amount of polymer fibers, wet fibers having a defined moisture content, for example in the range from 10% by weight of 40% by weight, were produced. For example, a solution prepared from 0.25 g of polyion complex solution and 4.04 g of water was added to 10 g of fibers in order to obtain wet fibers having 30% by weight of moisture. However, it was also possible to select the polyion complex solution arbitrarily from any of examples 1 to 12.

To an initial charge of 10 g of polymer fibers of the respective fiber lengths in a vessel was added a treatment agent produced from the respective polyion complex formulations. The mass composed of polymer fibers and treatment agent solution was processed and ultimately compressed with a flattened plunger. After the processing and compressing operation had been repeated once more, the vessel was closed and the compact polymer fiber mass was left to stand for 15 minutes.

To verify the ability of the wet-modified polymer fibers to function, about 50 mg was taken from the compact polymer fiber mass and transferred in each case either into a beaker or an Erlenmeyer flask—the vessels had each been charged with 200 g of water beforehand. As a result of the hydrophilic surface finish of the matted polymer fiber mass, the sample fell immediately to the base of the vessel on contact with water. The beaker was then stirred about five times with a 1 cm-thick stirrer bar, or the closed flask was shaken vigorously three times, and it was thus possible after a few moments to observe spontaneous fiber individualization of the previously compactly matted polymer fiber mass.

The results of these comparative studies are summarized in table 2:

TABLE 2
Determination of the individualization of polymer
fibers of different moisture content that had
been modified with polyion complexes beforehand

| | | Moisture | | |
|---|---|---|---|---|
| Polyion | Polyion | content of | Fiber | |
| complex | complex | the wet | type | Individual- |
| according | solution | fibers in % | Length | ization of the |
| to example | in g | by weight | in mm | wet fibers |
| 7 | 0.25 | 40 | PAC/6 | spontaneous |
| 7 | 0.1 | 40 | PAC/6 | spontaneous |
| 8 | 0.2 | 35 | PAC/6 | spontaneous |
| 9 | 0.2 | 30 | PAC/6 | spontaneous |
| 9 | 0.2 | 30 | PP/12 | spontaneous |
| 9 | 0.2 | 20 | PAC/8 | spontaneous |
| 9 | 0.2 | 20 | PAC/12 | spontaneous |
| 10 | 0.3 | 35 | PAC/6 | spontaneous |
| 10 | 0.15 | 20 | PAC/6 | spontaneous |
| 10 | 0.1 | 10 | PAC/6 | spontaneous |
| 10 | 0.2 | 20 | PAC/8 | spontaneous |
| 10 | 0.2 | 20 | PAC/12 | spontaneous |
| 11 | 0.2 | 40 | PAC/6 | spontaneous |
| 12 | 0.3 | 35 | PAC/6 | spontaneous |

### Example 15

The carbon fibers used for the study were short carbon fibers of the SFC 6 EPB type with diameter 7 μm for a single filament, fiber length 6 mm and size content 3%.

In three batches, an amount of 10 g of carbon fibers of the type named at the outset was treated in each case with mixtures of polyion complex solution, ricinoleic acid polyethylene glycol ester and water.

The mixtures were composed of:
0.2 g of polyion complex solution, 0.02 g of ricinoleic acid polyethylene glycol ester and 1.76 g of water,
0.2 g of polyion complex solution, 0.002 g of ricinoleic acid polyethylene glycol ester and 2.5 g of water, and
0.5 g of polyion complex solution, 0.02 g of ricinoleic acid polyethylene glycol ester and 1.76 g of water.

The above-described solutions were added in each case to an initial charge of 10 g of the carbon fibers in a petri dish. In order to distribute the solution, pressure was exerted on the mixtures of the fibers with the solutions described by means of a glass plunger over a period of about 5 minutes. Subsequently, the mixtures were transferred to plastic bags and pressure was exerted for a further 72 hours.

Of the carbon fibers prepared with polyion complex solutions, 0.5 g in each case was weighed into an Erlenmeyer flask with ground-glass neck in order to verify ability to individualize fibers. 15 ml of demineralized water was added to each initial charge of fibers, and the flask was closed with a stopper. Each of the flasks was shaken vigorously five times. Thereafter, distribution and individualization of the prepared fibers in the aqueous solution was apparent.

In the case of the untreated fibers, these were present unchanged in the form of a bundle. The results of the individualization experiments are summarized in table 3.

TABLE 3
Determination of the individualization of polymer fibers of different moisture content that
had been treated beforehand with polyion complex solutions and interface-active compounds.

| | | Ricinoleic acid | Moisture content | | |
|---|---|---|---|---|---|
| Polyion complex | | polyethylene | of the wet | | |
| according | Polyion complex | glycol ester | fibers in % | Fiber type/ | Individualization |
| to example | solution in g | in g | by weight | length in mm | of the wet fibers |
| 10 | 0.2 | 0.020 | 15 | SFC 6 EPB/6 | predominantly |
| | | | | | after shaking |
| 10 | 0.2 | 0.002 | 20 | SFC 6 EPB/6 | partly after |
| | | | | | shaking |
| 10 | 0.5 | 0.020 | 20 | SFC 6 EPB/6 | completely after |
| | | | | | shaking |

2.3 Use of the Carbon Fibers Modified With Polyion Complexes According to Example 15 For Production of Fiber-Containing Building Materials

### Example 16—Production of Gypsum Specimens

A mortar vessel was initially charged with 100 g of commercial gypsum (hardware store product). 1 g of the untreated carbon fibers of the SFC 6 EPB type or of the carbon fibers finished with polyion complexes according to example 15 was added. The mixtures were premixed in dry form for three minutes with a commercial food processor having kneading hooks, then 50 g of tap water was added in each case. Mixing was effected at the middle level for a further 2 minutes and then the excess was poured off, and then the remainder was left to stand for setting for 24 hours.

The resultant gypsum specimens were examined by light microscopy; light microscope images of the resultant gypsum specimens are shown in FIG. 1. It is clearly apparent that the gypsum specimen containing the carbon fibers modified with polyion complexes (FIG. 1, B) has much more homogeneous, individualized distribution of the fibers than the gypsum specimens that were produced with untreated carbon fibers (FIG. 1, A).

### Example 17—Production of Cement-Bound Specimens

A mortar vessel was initially charged with 14.9 g of commercial cement (CEM II 32.5R), 34.8 g of ground limestone and 149 g of sand. 0.5 g of the untreated carbon fibers of the SFC 6 EPB type or of the carbon fibers finished with polyion complexes according to example 15 was added. The mixture was mixed cautiously by hand. Thereafter, 24 ml of tap water with 1 ml of flux (ViscoCrete 1020x, Sika) was added to the dry mixtures and stirred with a handheld mixer with kneading hooks for 3.5 minutes, beginning at a lower level, then at a moderate level, and the excess was poured off, and the remainder was then left to stand for setting for 4 weeks.

### BRIEF DESCRIPTION OF THE FIGURES

FIG. 1 shows light microscope images of the gypsum samples produced with carbon fibers of the SFC 6 EPB type that were untreated (A) or had been prepared (B) with polyion complex solution and interface-active compound (100 g of gypsum and 50 g of water and 1 g of fibers).

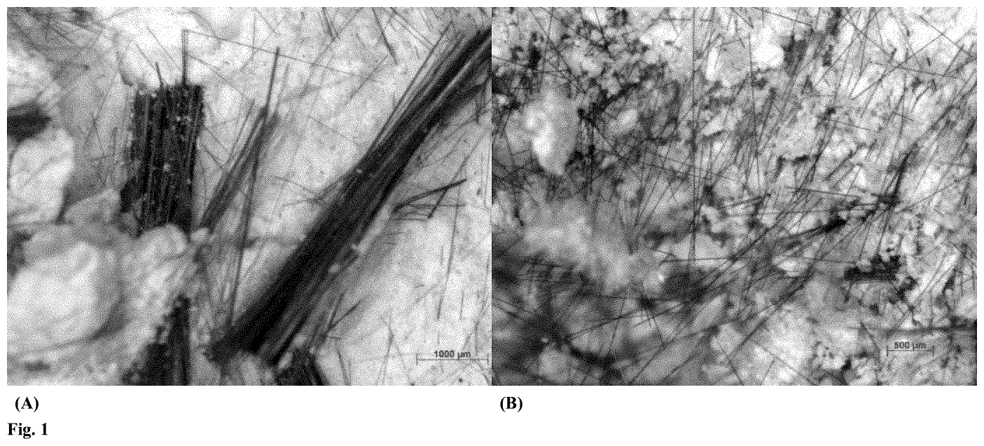

### LITERATURE CITED

DE 602 22 301 T2 (2002)
Company brochure from Baumbach Metall GmbH on the topic of “Polypropylenfasern zur Reduzierung von Schwindrissen”
DE 201 21 159 U1 (2001)
EP 1 288 176 B1 (2001)
V. Mechtcherine [Institute of Construction Materials, TU Dresden (2012), Part 2: Faserbeton]
B. Philipp and G. Reinisch “Grundlagen der makromolekularen Chemie”, Akademie-Verlag-Berlin, 1976

1-6. (canceled)

7. A polyion complex comprising x mol of polycations and y mol of polyanions, wherein the polyion complex has the general formula (I) 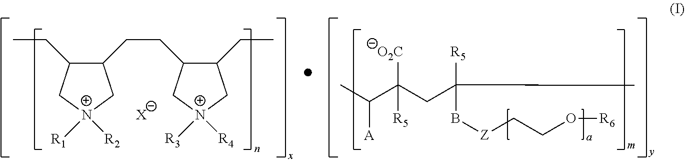
wherein:
R₁, R₂ are independently selected from the group consisting of hydrogen atom, C₁ to C₈-alkyl radical, polyethylene glycol radical —[CH₂—CH₂—O]ₐ—H, and polyethylene glycol methyl ether radical —[CH₂—CH₂—O]ₐ—CH₃, wherein a is an integer in the range from 1 to 100;
X⁻ is a halide anion or methosulfate anion;
R₃, R₄:
are either independently selected from the group consisting of hydrogen atom, C₁ to C₈-alkyl radical, polyethylene glycol radical —[CH₂—CH₂—O]ₐ—H, and polyethylene glycol C₁ to C₁₈-alkyl ether radical, wherein a is an integer in the range from 1 to 100;
or
represent a radical of the general formula (II) 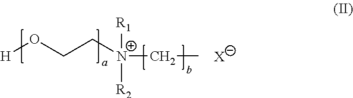
wherein X⁻, R₁, R₂ and a have the definitions given above for the general formula (II), b is 2 or 3;
or
represent a radical of the general formula (III) 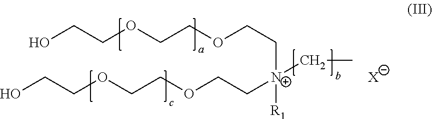
in which X⁻, R₁, a and b have the definitions given above for the general formula (II) or (III) and c is an integer in the range from 1 to 100;
R5 is a hydrogen atom or a methyl group;
R₆ is a hydrogen atom or a C₁ to C₁₈-alkyl radical;
A is a hydrogen atom, a carboxylate anion —CO₂⁻ or a carboxylate sodium —CO₂Na,
B is a methylene group —CH₂— or a carbonyl group —CO—, or the bridge group is absent,
Z is an oxygen atom or a nitrogen radical NR₆ with the definition already given for R₆;
n, m are independently either the same or different and denote the degree of polymerization that represents the number of monomeric repeat units in the polymer,
x, y are numbers from the range from 1 to 100.

8. The process for preparing a polyion complex according to claim 7, comprising:
1. providing an aqueous solution of a polycation component or an aqueous solution of a polyanion component; and
2. adding an aqueous solution of a polyanion component or an aqueous solution of a polycation component to the aqueous solution of the polycation component or of the polyanion component provided in (1);
to obtain an aqueous solution of a polyion complex.

9. The process for preparing a polyion complex as claimed in claim 8, wherein the addition in step (2) is effected at a temperature in the range from 0° C. to 50° C.

10. An aqueous solution of a polyion complex obtained by the process as claimed in claim 8.

11. An aqueous solution of a polyion complex according to claim 7.

12. The aqueous solution of a polyion complex as claimed in claim 11, wherein the polyion complex is in aqueous solution;
and/or
wherein the aqueous solution of the polyion complex comprises more than 10% by weight of water, based on the total weight of the respective aqueous solution;
and/or
wherein the aqueous solution of the polyion complex comprises 0.01% to 5.0% by weight of polyion complex, based on the total weight of the respective aqueous solution.

13. A method of using the polyion complex as claimed in claim 7, the method comprising using the polyion complex for surface modification of polymer fibers and/or carbon fibers.

14. A process for surface modification of polymer fibers and/or carbon fibers, comprising:
a) providing polymer fibers and/or carbon fibers;
b) providing an aqueous solution of a polyion complex according to claim 7;
c) mixing the polymer fibers and/or carbon fibers provided in (a) and the aqueous solution of the polyion complex from (b) to obtain an aqueous mixture comprising surface-modified polymer fibers and/or carbon fibers;
d) separating the surface-modified polymer fibers and/or carbon fibers from the aqueous mixture in (c) to obtain wet surface-modified polymer fibers and/or carbon fibers having a water content of 0.1% to 50% by weight;
e) compacting the wet fibers obtained in (d) to obtain compacted wet fibers;
f) optionally drying the surface-modified polymer fibers and/or carbon fibers separated in (d) or the wet fibers compacted in (e).

15. Surface-modified polymer fibers and/or carbon fibers, obtained by the process as claimed in claim 14.

16. Surface-modified polymer fibers and/or carbon fibers having a coating based on a polyion complex according to claim 7 on at least part of the polymer fiber or carbon fiber surface.

17. A method of using surface-modified polymer fibers and/or carbon fibers as claimed in claim 16, the method comprising using the surface-modified polymer fibers and/or carbon fibers for production of fiber-modified building materials.

18. A fiber-modified building material comprising surface-modified polymer fibers and/or carbon fibers as claimed in claim 16.

19. The process for preparing a polyion complex as claimed in claim 7, wherein x≥y or x≤y.

20. The process for preparing a polyion complex as claimed in claim 8, wherein the addition in step (2) is effected at a temperature between 15° C. and 30° C.

21. The aqueous solution of a polyion complex as claimed in claim 11, wherein the polyion complex is in aqueous solution, wherein ≥90% by weight of the aqueous solution of the poly ion complex consists of poly ion complex and water;
and/or
wherein the aqueous solution of the polyion complex comprises more than 20% by weight of water, based on the total weight of the respective aqueous solution;
and/or
wherein the aqueous solution of the polyion complex comprises 0.1% to 3.0% by weight of polyion complex, based on the total weight of the respective aqueous solution.

22. The method of use of claim 13, wherein the surface modification comprises surface hydrophobization.

23. The method of use of claim 13, wherein the polymer fibers are selected from the group consisting of thermoplastic polymer fibers, polyacrylonitrile fibers, polyester fibers, polyurethane fibers, polyamide fibers, polyvinylalcohol fibers, polyethylene fibers, polypropylene fibers and mixtures of two or more of these polymer fibers.

25. The process of claim 14, wherein the surface modification comprises surface hydrophobization.

27. The process of claim 14, wherein the compacting comprises mechanically compacting on the industrial scale or on the laboratory scale the wet fibers obtained in (d) to obtain compacted wet fibers.

28. The fiber-modified building material of claim 18, comprising a fiber-modified gypsum, concrete or mortar system.
